(19) United States
(12) Patent Application Publication
(10) Pub. No.: US 2017/0307884 A1
(43) Pub. Date: Oct. 26, 2017

(54) CONTROL DEVICE, HEAD-MOUNT DISPLAY DEVICE, PROGRAM, AND CONTROL METHOD FOR DETECTING HEAD MOTION OF A USER

(71) Applicant: NIKON CORPORATION, Tokyo (JP)

(72) Inventors: Seiji TAKANO, Yokohama-shi (JP); Masaki OTSUKI, Yokohama-shi (JP); Akinobu SUGA, Tokyo (JP); Nobuhiro FUJINAWA, Yokohama-shi (JP); Hidenori KURIBAYASHI, Tokyo (JP)

(73) Assignee: NIKON CORPORATION, Tokyo (JP)

(21) Appl. No.: 15/647,963

(22) Filed: Jul. 12, 2017

Related U.S. Application Data
(63) Continuation of application No. 14/853,784, filed on Sep. 14, 2015.
Application No. 14/853,784 is a continuation of application No. 12/741,152, filed on May 3, 2010, now abandoned.

(30) Foreign Application Priority Data
Nov. 16, 2007 (JP) 2007-297513
Sep. 3, 2008 (JP) 2008-225843
Sep. 16, 2008 (JP) 2008-236152

(51) Int. Cl. G02B 27/01; G06F 3/01; H04N 21/422; G06F 3/0485; H04N 5/44

(52) U.S. Cl. CPC G02B 27/017; G06F 3/0485; G06F 3/012; H04N 21/42219; H04N 21/42222; G02B 2027/0187; G02B 2027/014; H04N 2005/4428

(57) ABSTRACT

It is possible to provide a technique for accurately performing an operation desired by a user. A user's head operation is identified according to information detected by a head motion detection unit. A process desired by the user is executed according to an angular velocity of the head motion. Moreover, the technique uses a control unit which can accurately execute an operation by the user's head operation without reflecting the return motion of the user's head in the process. The control unit executes a process for a start and an end of each process corresponding to the detected angular velocity according to a predetermined threshold value.

### TECHNICAL FIELD

The present invention relates to a technique of detecting a motion of a human body in order to exercise specific control.

### BACKGROUND ART

There is known a head-mount display device that detects a user's head motion and exercises control according to specific motions. For detecting a head motion, such a head-mount display device uses various kinds of sensors such as for example a gyro sensor (angular velocity sensor), an acceleration sensor, a magnetic sensor, and the like. Various techniques have been developed in order to improve operability of a head-mount display device based on such various kinds of sensors.

For example, Patent Document 1 discloses a technique of reflecting a user's head motion detected by sensors on displaying of information on a display of a head-mount display device.

Further, Patent Document 2 disclose a technique of using data of rotation angles detected by gyro sensors respectively around triaxial directions perpendicular to one another and data of respective azimuth angles of the same triaxial directions detected by magnetic sensors, Drift components included in the rotation angle data detected by the gyro sensors are compensated by using the azimuth angle data obtained by the magnetic sensors, and thus detection errors are reduced.

Patent Document 1: Japanese Un-examined Patent Application Laid-Open No. 11-161190

Patent Document 2: Japanese Un-examined Patent Application Laid-Open No. 11-248456

In the technique described in Patent Document 1, however, a user cannot use his head motion to instruct the device to perform desired operation, and thus the must manually operate the device. Further, it is possible that unintended operation is performed due to a return motion or the like of the user's head.

And in the technique described in Patent Document 2, both types of sensors, i.e. gyro sensors and magnetic sensors are used to correct an attitude, and thus the circuit size becomes larger and costs higher, and in addition higher computing power is required.

Thus, an object of the present invention is to provide a technique, according to which operation intended by a user can be performed much faster and more accurately.

### DISCLOSURE OF THE INVENTION

To solve the above problems, a head-mount display device of the present invention comprises: a motion detection unit for detecting a motion of a user who is mounting the control device; and a control unit that performs a first processing when a velocity (which is detected by the motion detection unit) of a user's motion in a specific direction is higher than or equal to a velocity determined by a first threshold, and a second processing when the velocity of the user's motion in the specific direction is higher than or equal to a velocity determined by a second threshold, where the velocity determined by the second threshold is lower than the velocity determined by the first threshold.

Thus, the present invention can provide a technique according to which the head-mount display device can perform processing while recognizing more quickly and more accurately operation intended by a user.

### BRIEF DESCRIPTION OF DRAWINGS

FIG. 1 is a perspective view of an HMD 101 according to a first embodiment of the present invention;

FIG. 2 is a side view of the HMD 101;

FIG. 3 is a block diagram showing a functional configuration of the HMD 101;

FIG. 4A is a schematic diagram showing flag information 700 and FIG. 4B is directional information 701;

FIG. 5 is a chart showing time course of angular velocity of head motion in the case where a control unit 310 performs a scroll process;

FIG. 6 is a chart showing time course of angular velocity of head motion in the case where the control unit 310 performs a screen switching process;

FIG. 7 is a flowchart showing processing performed when the control unit 310 receives a voltage value sent from a head motion detection unit 200;

FIG. 8 is a flowchart showing a scroll process performed when the control unit 310 receives a voltage value sent from the head motion detection unit 200;

FIG. 9 is a flowchart showing an un-sensing motion process performed when the control unit 310 receives a voltage value sent from the head motion detection unit 200;

FIG. 10 is a flowchart showing a screen switching process performed when the control unit 310 receives a voltage value sent from the head motion detection unit 200;

FIG. 11 is a block diagram showing a functional configuration of an HMD 102 according to a second embodiment of the present invention;

FIG. 12 is a flowchart showing processing performed when a control unit 410 receives a voltage value sent from the head motion detection unit 200;

FIG. 13 is a schematic view showing an example of display by an indicator 800;

FIG. 14 is a flowchart showing processing performed when the control unit 310 receives a voltage value sent from the head motion detection unit 200;

FIG. 15 is a block diagram showing a functional configuration of an HMD 103 according to a third embodiment of the present invention;

FIG. 16 is a flowchart showing a correction process performed by a control unit 510;

FIG. 17 is a chart showing time course of angular velocity of rotational motion around the X-axis;

FIG. 18 is a schematic diagram showing a relation between a user's coordinate system XYZ and a coordinate system X′Y′Z′ of an angular velocity sensor;

FIG. 19 is a block diagram showing a functional configuration of an HMD 104 according to a fourth embodiment of the present invention;

FIG. 20 is a flowchart showing a warning process performed by a control unit 610;

FIG. 21 is a block diagram showing a functional configuration of an HMD 105 according to a fifth embodiment of the present invention;

FIG. 22 is a chart showing time course of angular velocity in the case where screen switching process is performed;

FIG. 23 is a chart showing time course of angular velocity in the case where screen switching process is not performed;

FIG. 24 is a schematic diagram showing threshold information 901;

FIG. 25 is a schematic diagram showing setting information 902;

FIG. 26 is a flowchart showing a flow in the case where a motion analysis unit 911 performs screen switching process;

FIG. 27 is a block diagram showing a functional configuration of an HMD 106 according to a sixth embodiment of the present invention;

FIG. 28 is a flowchart showing a flow of a threshold setting process by a threshold setting unit 1014;

FIG. 29 is a chart showing time course of stable angular velocity;

FIG. 30 is a chart showing time course of unstable angular velocity; and

FIG. 31 is a block diagram showing an electrical configuration of the HMD 101.

### REFERENCE SYMBOLS

101, 102, 103, 104 and 105: HMD; 110: head-mounting band; 120: sound output unit; 130A and 130B: housing; 140: supporting unit; 150: arm unit; 160: display unit; 170: operation unit; 171A, 171B, 171C, 171D and 171E: operating switch; 172: remote control receiving unit; 180: power supply unit; 200: head motion detection unit; 300, 400, 500, 600, 900 and 1000: control device.

### BEST MODE FOR CARRYING OUT THE INVENTION

Now, the best mode for carrying out the invention will be described referring to the drawings.

### First Embodiment

A head-mount display device (hereinafter, briefly referred to as HMD) 101 of the present embodiment identifies different kinds of processing instructed by user's motions in the same direction, on the basis of the amplitude of the head motion, while preventing execution of unintended processing caused by a return motion of the user's head.

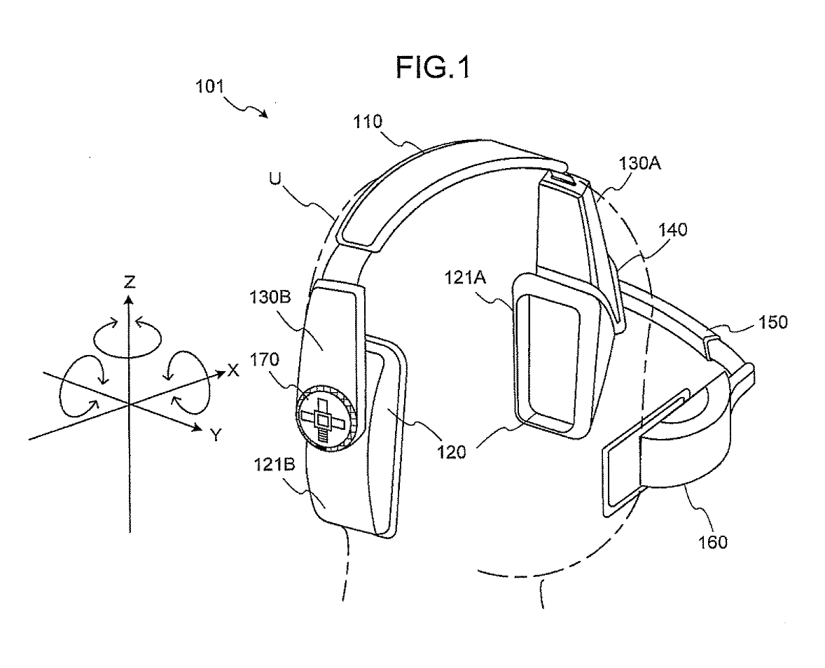

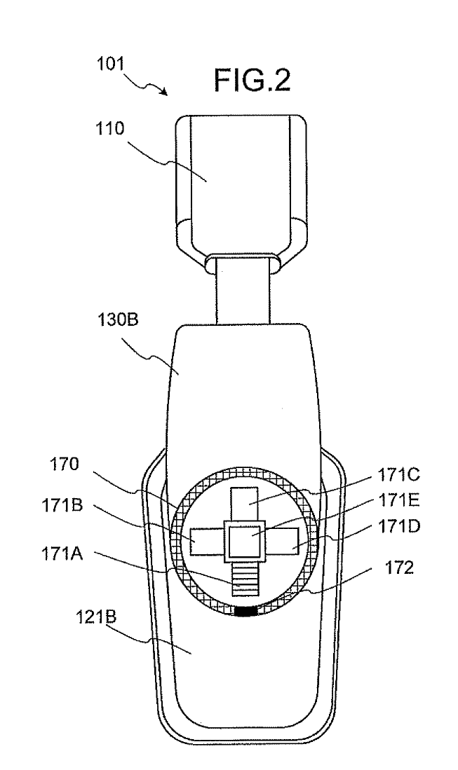

FIGS. 1 and 2 show the head mount display device 101. FIG. 1 is a perspective view showing the HMD 101 of the first embodiment of the present invention, and FIG. 2 is a side view showing the HMD 101 of the first embodiment.

As shown in the figures, the HMD 101 of the present embodiment comprises a head-mounting band 110, a sound output unit 120, housings 130A and 130B, a supporting unit 140, an arm unit 150, a display unit 160, and an operation unit 170.

The head-mounting band 110 is formed into a curved shape such that both ends face each other. Further, the head-mounting band 110 is made of elastic material, so that speakers 121A and 121B (simply referred to by 121 when it is not necessary to distinguish between them) formed respectively at its ends are pressed toward the inside of the user's head when it is put on the user's head. Thus, the HMD 101 can be mounted on the user's head in a detachable manner.

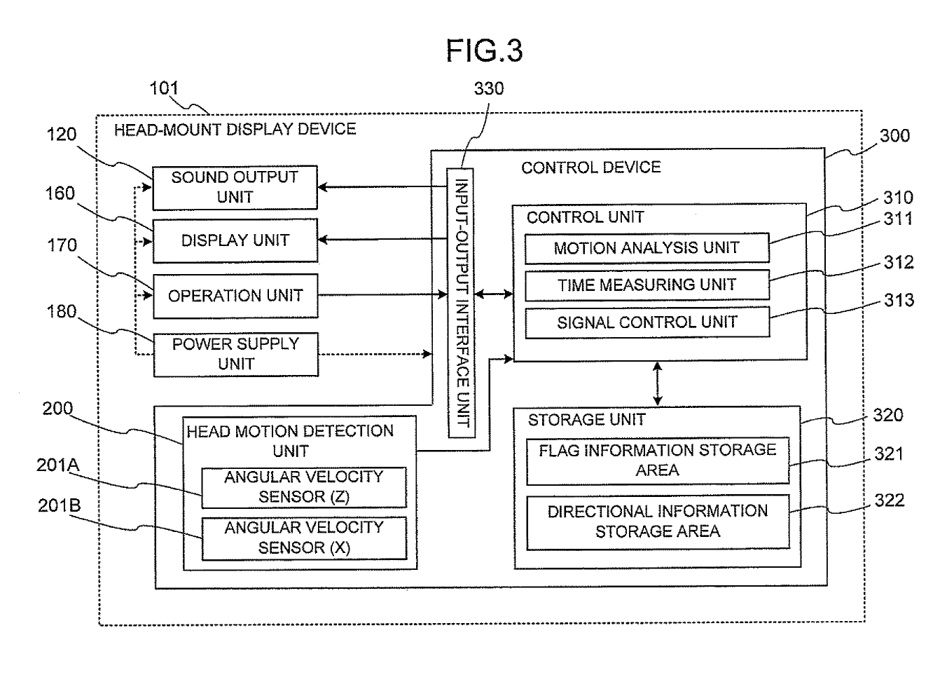

Housings 130A and 130B are connected respectively to both end sides of the head-mounting band 110. The housing 130A is provided with the speaker 121A, and the housing 130B with the speaker 121B. Further, in the inside of the head-mounting band 110, there is wiring of signal lines for electrically connecting the speakers 121A and 121B, the operation unit 170, the display unit 160 and a power supply unit 180 (See FIG. 3) and a power line for supplying electric power from the power supply unit 180 placed within the below-described housing 130B.

The sound output unit 120 converts a sound signal into sound. In the present embodiment, the sound output unit 120 has the speakers 121A and 121B, which are so-called headphone speakers and put on bath ears when used. In FIG. 1, the speaker 121A seen on the right is a speaker for a left ear, and the speaker 121B on the left is a speaker for a right ear. It may be arranged that the left and right speakers can be determined arbitrarily by user's operation. Further, the sound output unit 120 has wiring of a power line for supplying power from the power supply unit 180 and wiring of a sound signal line for supplying a sound signal.

The housings 130A and 130B are provided on both side ends in the longitudinal direction of the head-mounting band 110. To the external wall of the housings 130A and 130B on the sides of the user's head (i.e. the sides facing each other), the speakers 121A and 121B are connected respectively. In the present embodiment, the housing 130B contains a control device 300 and the power supply unit 180 shown in FIG. 3. Further, the housing 130B has the operation unit 170 on the external wall on the opposite side to the speaker 121B.

The power supply unit 180 is connected to the sound output unit 120, the display unit 160, the operation unit 170 and the control device 300 through the power line. On the external wall of the housing 130A on the opposite side to the speaker 121A, a power switch (not shown) is provided for switching on/off of the power of the HMD 101.

Each of the power supply unit 180, the control device 300, the operation unit 170 and the power switch may be located at either of the housings 130A and 130B. Further, the housings 130A and 130B may be formed integrally with the respective speakers 121A and 121B.

The supporting unit 140 connects one end side of the arm unit 150 to the housing 130A in a rotatable manner. Any connecting method may be employed. Thus, the user can wear the HMD 101 such that the speakers 121A and 121B are placed at the inversed positions, and rotate the arm unit 150 through 180 degrees to use the HMD 101 in a state that the display unit 160 is positioned in front of his eye. Due to this arrangement, the user can position the display unit 160 in front of either of the left and right eyes.

The arm unit 150 is curved in the longitudinal direction so that the display unit 160 (attached to the arm unit 150 at the other end than the end on the housing 130A side) is positioned in front of the user's eye when the head-mounting band 110 is mounted on the user's head. Further, in the inside of the arm unit 150, there is wiring of a power line for supplying power to the display unit 160 and an image signal line for supplying an image signal.

The display unit 160 is connected to the tip of the arm unit 150 in a rotatable manner, in order to be aligned with user's line of sight. The display unit 160 comprises, for example, a display device and an optical system for magnifying a displayed image, and displays an image on the basis of an image signal supplied from the control device 300.

The operation unit 170 comprises operating switches 171A, 171B, 171C, 171D and 171E, and further a power switch not shown in the figure. Through each operating switch, the user can input an instruction to execute a function of the HMD 101 such as play, stop, fast-forward, fast-rewind, cancel of control processing, or change of sound volume, for example. An instruction inputted through an operating switch is sent to a control unit 310 through an I/F unit 330.

The operation unit 170 comprises operating switches 171A, 171B, 171C, 171D and 171E, and further a power switch not shown in the figure. Through the operating switches 171A, 171B, 171C, 171C, 171D and 171E, it is possible to input an instruction to execute a function of the HMD 101 such as play, stop, fast-forward, fast-rewind, cancel of control processing, or change of sound volume, for example. When an operation instruction is inputted through these switches, the instruction is sent to a control unit 310 through an I/F unit 330.

Further, it is possible to provide separately a remote control (not shown) that can be used to operate the HMD 101. Using the remote control, the user can operate the HMD 101 by wireless or by wire while seeing operating switches. Further, the remote control may have a control device 300 or a power supply unit 180 within it. Further, in the case where wireless operation is used, the operation unit 170 may be provided with a remote control receiving unit 172.

Next, referring to FIG. 3, the HMD 101 of the first embodiment of the present invention will be described. FIG. 3 is a block diagram showing a functional configuration of the HMD 101.

First, the control device 300 will be described. As shown in FIG. 3, the control device 300 comprises a head motion detection unit 200, the control unit 310, a storage unit 320, and the I/F unit 330.

The head motion detection unit 200 is a device for detecting a motion of the head, and comprises an angular velocity sensor (Z) 201A and an angular velocity sensor (X) 201B (simply referred to by 201 when it is not necessary to differentiate between them). The head motion detection unit 200 detects an angular velocity as directional information on a motion of a detection object i.e. the user's head in relation to specific reference axes. As shown in FIG. 1, in the head motion detection unit 200 of the first embodiment of the present invention, the vertical direction (the direction in which the user stands upright) is taken as a Z-axis, and an axis that intersects the Z-axis at right angles and extends in the direction that passes from one side of the user to the other side (i.e. the direction passing through the speakers 121A and 121B) is taken as an X-axis. These two axes are the reference axes, based on which an angular velocity is detected.

As the angular velocity sensor (Z) 201A and the angular velocity sensor (X) 201B, it is possible to employ piezoelectric vibrating gyros using piezoelectric ceramics.

As shown in FIG. 1, the angular velocity sensor (Z) 201A detects an angular velocity in the yaw direction, or a yaw angle as an inclination of rotation angle around the Z-axis. And, the angular velocity sensor (X) 201B detects an angular velocity in the pitch direction, or a pitch angle as an inclination of rotation angle around the X-axis. Using such sensors, it is possible to detect a lateral swing motion and a vertical swing motion of the user's head. In the present embodiment, the angular velocity sensors take samples at prescribed intervals (for example, at intervals of 50 msec), and each detection result is outputted as an analogue voltage value that is proportional to an angular velocity. An outputted voltage value is converted to a digital signal through an A/D converter (not shown) and sent to the control unit 310 of the control device 300.

Further, the number of angular velocity sensors 201 is not limited to the above-described one. For example, in order to detect a tilting motion of the user's head, it is possible to provide another angular velocity sensor whose reference axis is the Y-axis for detecting a roll angle of the tilting motion. Or, it is possible to arrange that one angular velocity sensor detects all angular velocities.

Further, in addition to the angular velocity sensors 201, an acceleration sensor may be provided. Or, all the sensors can be acceleration sensors, instead of angular velocity sensors.

The I/F unit 330 connects the sound output unit 120, the display unit 160, the operation unit 170 and the power supply unit 180 to the control device 300. Further, the I/F unit 330 may have a general-purpose bus terminal for connecting the HMD 101 with an external device in a data-transferable manner, a wireless LAN module for connecting to a network, or the like.

The storage unit 320 comprises a flag information storage area 321 and a directional information storage area 322.

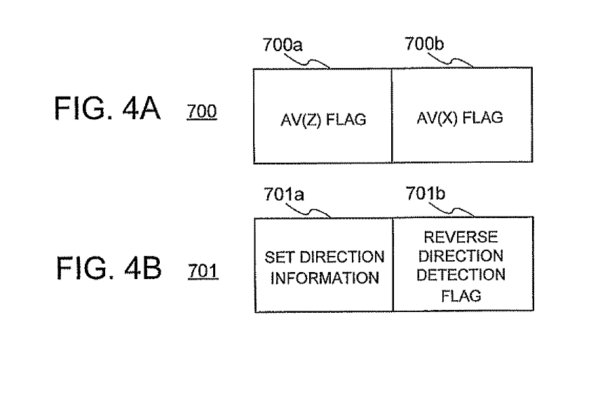

The flag information storage area 321 stores flag information 700 (See FIG. 4A). The flag information 700 has an AV(Z) flag storage area 700a and an AV(X) flag storage area 700b. These areas register flags indicating that a motion analysis unit 311 has detected values less than or equal to a threshold Th₃ with respect to angular velocity of a rotation angle around the Z-axis (yaw angle) and angular velocity of a rotation angle around the X-axis (pitch angle) respectively in the below-described scroll process.

The directional information storage area 322 stores directional information 701 (See FIG. 4B). The directional information 701 has a set direction information storage area 701a and a reverse direction detection flag storage area 701b. The set direction information storage area 701a stores, as set direction information, information that is used by the motion analysis unit 311 in the below-described screen switching process and indicates the direction of an angular velocity, for example Z+(rightward direction), Z− (leftward direction), X− (upward direction) or X+(downward direction). The reverse direction detection flag storage area 701b registers a flag indicating that an angular velocity in the reverse direction to the set direction has been detected.

The storage unit 320 stores data of images and music to be reproduced in the HMD 101 and a history of angular velocities detected by the angular velocity sensors 201.

In the following, an angular velocity obtained from the voltage value of the angular velocity sensor (Z) 201A for indicating a movement in the horizontal direction is expressed as AV(Z), and an angular velocity obtained from the voltage value of the angular velocity sensor (X) 201B for indicating a movement in the vertical direction is expressed as AV(X). Further, in the following description, among yaw angle directions detected by the angular velocity sensor (Z), the rightward direction is expressed as Z+, and the leftward direction as Z−. And, among pitch angle directions detected by the angular velocity sensor (X), the upward direction is expressed as X−, and the downward direction as X+.

Next, processing executed by the control unit will be described. The control unit 310 comprises the motion analysis unit 311, a time measuring unit 312, and a signal control unit 313.

On receiving voltage values sent from the angular velocity sensors (Z) and (X) 201A, 201B, the motion analysis unit 311 calculates angular velocities AV(Z) and AV(X) of the head motion on the basis of the received voltage values and previously-generated reference values, and performs prescribed processing according to the calculated angular velocities.

The time measuring unit 312 comprises three timers (not shown), i.e. a setting timer, an un-sensing motion timer, and a screen switching timer. On receiving a start request for a timer from the motion analysis unit 311, the time measuring unit 312 starts operation of the timer whose start has been requested. Then, when a prescribed time determined for that timer has elapsed, the time measuring unit 312 stops the timer, and outputs a timer end response to the motion analysis unit 311. It is possible to arrange that each timer initiates countdown of the prescribed time from the start time.

The signal control unit 313 generates and outputs control signals corresponding to a head motion, for example, an image signal to output to the display unit 160, a sound signal to output to the sound output unit, and the like. Similarly, the signal control unit 313 also performs generation and output processing of signals corresponding to a user's instruction received through the operation unit 170.

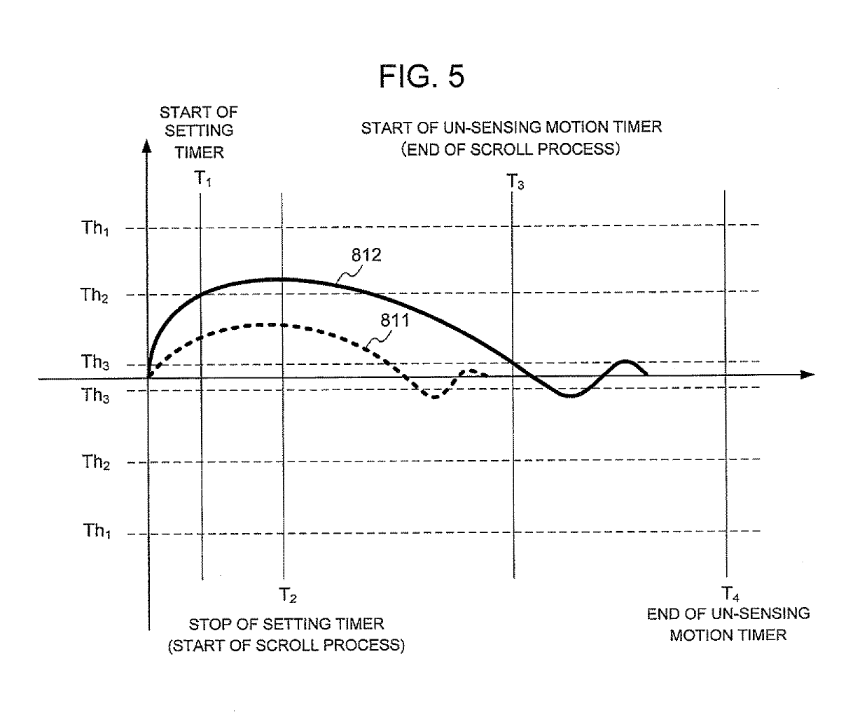

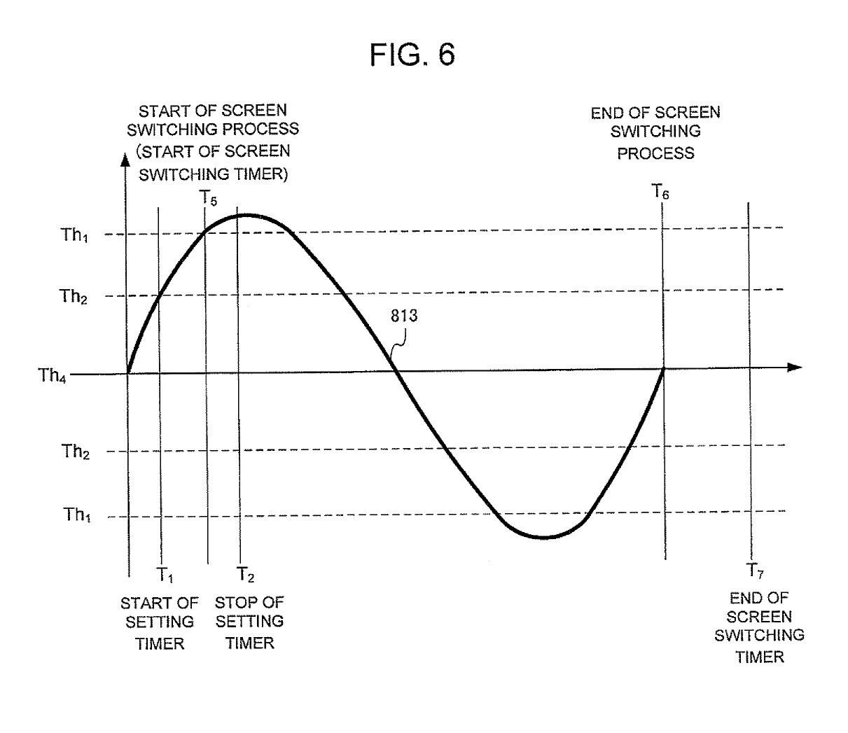

Next, operation performed by the control unit 310 will be described in detail referring to FIGS. 5-10. FIG. 5 is a chart showing an example of time course of angular velocity when the control unit 310 performs a scroll process. And, FIG. 6 is a chart showing an example of time course of angular velocity when the control unit 310 performs a screen switching process.

In the charts shown in FIGS. 5 and 6, the horizontal axes indicate time, and the vertical axes indicate angular velocity. Further, coordinates on the upper side of the horizontal axis indicate angular velocities of head motions in the downward direction and the rightward direction, and coordinates on the lower side of the horizontal axis indicate angular velocities in the upward direction and the leftward direction.

In FIG. 5, a dashed line 811 shows time course of the angular velocity AV(Z) (in the horizontal direction), and a solid line 812 shows time course of the angular velocity AV(X) (in the vertical direction).

A threshold Th₁ is angular velocity required for the user to instruct screen switching operation, and a threshold Th₂ is angular velocity required for the user to instruct screen scroll operation. These thresholds are set in order to identify velocity of rotation of the user's head. Prescribed values are set as these thresholds Th₁ and Th₂ for each of vertical and horizontal directions (for example, Th₁=70-80°/s and Th₂=25-35°/s).

As Th₁ and Th₂, larger values are set for the direction in which head motion can be made more easily (for example, the downward direction or the rightward direction) than for the other direction of the upward and downward directions or the leftward and rightward directions. By this arrangement, it is possible to operate naturally in all directions. Of course, these values can be changed appropriately according to the conditions of use or the like. In FIG. 5, Th₁ and Th₂ are each shown as a single magnitude for both directions.

Further, in the present embodiment, Th₁ has a larger value than Th₂ so that operation for executing the screen switching process requires larger angular velocity of head motion than operation for executing the scroll process. Each threshold may be set in advance. Or, it is possible to arrange that each threshold can be changed appropriately.

A threshold Th₃ is a prescribed value set in order to finish the screen scroll process, and a threshold Th₄ in order to finish the screen switching process. To prevent frequent switching of screen, it is desirable that Th₃ and Th₄ (FIG. 6) are smaller than Th₁ and Th₂ and exist in a neighborhood of 0°/s or are set to 0°/s. In FIG. 5, Th₃ is shown as a value existing in a neighborhood of 0°/s. And, in FIG. 6, Th₄ is shown to be 0°/s.

Next, will be described a time point when the control unit 310 performs some process.

T₁ is a time point at which an absolute value of AV(Z) or AV(X) becomes more than or equal to the threshold Th₂ and the time measuring unit 312 starts the setting timer. In FIGS. 5 and 6, the absolute value of AV(X+) (downward movement) becomes more than the threshold Th₂.

T₂ is a time point at which a previously-determined operating time of the setting timer elapses and the time measuring unit 312 stops the setting timer.

In FIG. 5, at the time point T₂, the absolute value of AV(X) shown by the solid line 812 exists in a range between the thresholds Th₁ and Th₂. In such a case, the scroll process for scrolling the screen is started at the time point T₂.

In FIG. 6, at a time point T₅ before T₂, the absolute value of AV(X) reaches the threshold Th₁. In such a case, the screen switching process for switching the screen is started at the time point T₅. Thus, since the screen switching process is started when the absolute value of angular velocity reaches the threshold Th₁ while the setting timer is operating, the screen switching process will have been already started at the time point T₂. Simultaneously with the start of the screen switching process, the screen switching timer is started.

T₃ is a time point at which both absolute values of AV(Z) and AV(X) become less than or equal to the threshold Th₃ after T₂. At this point, the time measuring unit 312 starts the un-sensing motion timer and the scroll process ends.

In FIG. 5, the absolute value of AV(Z+) (rightward motion) of the dashed line 811 becomes less than or equal to the threshold Th₃ earlier, and thus the time point at which the absolute value of AV(X) becomes less than or equal to the threshold Th₃ is determined as T₃. At this point, the scroll process ends and an un-sensing motion process (the un-sensing motion timer) is started. During the un-sensing motion process, angular velocity is not made to be reflected on the control.

T₄ is a time point when a previously-determined operating time of the un-sensing motion timer elapses and the time measuring unit 312 stops the un-sensing motion timer, and the un-sensing motion process ends. Thus, in FIG. 5, angular velocity in the period from T₃ to T₄ is not reflected on the actual control.

T₆ is a time point at which, in the course of the screen switching process after T₅, the angle direction opposite to the angle direction (set direction) of angular velocity (which became more than or equal to the threshold Th₁.

at T₅) reaches the threshold Th₄, and is going to have again the same direction as the set direction of T₅. At this point (i.e. when a return motion is started), the screen switching process finishes.

As for the solid line 813 shown in FIG. 6, T₆ is the point at which AV(X−) (upward motion) in the reverse direction to AV(X+) (downward motion) reaches the threshold Th₄ and is going to become AV(X+) (downward motion) again.

Further, T₇ is a time point at which a previously-determined operating time of the screen switching timer elapses and the timer is stopped. If the absolute value of angular velocity in the reverse direction to the set direction does not reach the threshold Th₄ after T₅, the screen switching process is ended at the time point T₇.

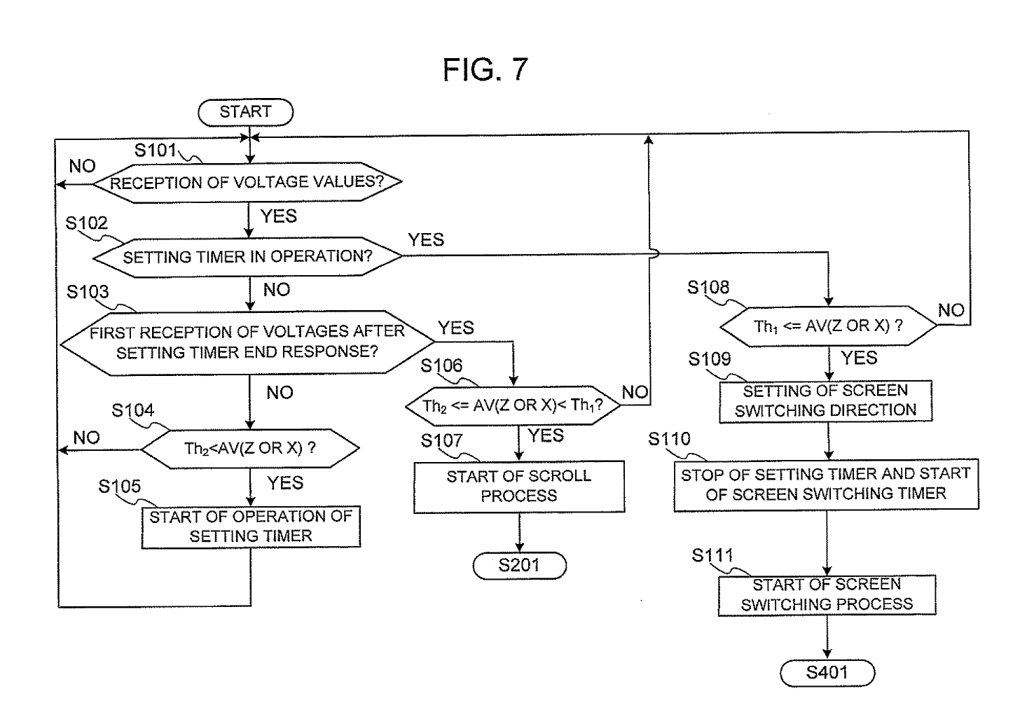

FIG. 7 is a flowchart showing processing performed when the control unit 310 of the HMD 101 of the first embodiment receives a voltage value sent from the head motion detection unit 200.

When the motion analysis unit 311 receives voltage values that are detected by and outputted from the angular velocity sensor (Z) 201A and the angular velocity sensor (X) 201B at prescribed intervals (here, assumed to be ones of 50 msec) (S101). Then, the motion analysis unit 311 calculates the true variation of the head motion by subtracting the prescribed reference values from the received voltage values, to obtain the angular velocities AV(Z) and AV(X).

Next, the motion analysis unit 311 detects whether the setting timer provided in the time measuring unit 312 is in operation or not (S102). If the setting timer is in operation (YES), the processing proceeds to the step 108. If the setting timer is not in operation (NO), the processing proceeds to the step 103.

In order to judge whether a timer is in operation or not, it may be detected whether a timer end response has been received from the time measuring unit 312, as described below, or it may be arranged that a request for information on timer operation is made appropriately (The same shall apply hereinafter).

In the step 103, the motion analysis unit 311 judges whether the voltage value received in the step 101 is the first one after reception of a setting timer end response. If the received voltage value is the first one after reception of a setting timer end response (YES), the processing proceeds to the step 106. If not (NO), the processing proceeds to the step 104.

In the step 104, the motion analysis unit 311 judges whether the absolute value of the angular velocity AV(Z) or AV(X) is more than or equal to the threshold Th₂. If both or one of the absolute values of the angular velocities AV(Z) and AV(X) is more than or equal to the threshold Th₂ (YES), then the motion analysis unit 311 requests the time measuring unit 312 to start the setting timer and the processing proceeds to the step 105. If both absolute values of the angular velocities are less than Th₂ (NO), then the processing returns to the step 101 to repeat the processing.

In the step 105, the time measuring unit 312 makes the setting timer start its operation. Further, after elapse of the prescribed time, the time measuring unit 312 makes the setting timer stop its operation, and outputs a setting timer end response to the motion analysis unit 311.

Returning to the step 103, if the received voltage value is the first one after reception of a setting timer end response (YES), then the motion analysis unit 311 detects whether the absolute value of the angular velocity AV(Z) or AV(X) falls within the range between the threshold Th₂ and the threshold Th₁ (Th₂<=AV(Z or X)<Th₁) (S106). If both or one of the absolute values of the two angular velocities falls within the range between the threshold Th₂ and the threshold Th₁ (YES), then the scroll process is started (S107) and the processing is ended. If both absolute values of the angular velocities are outside the range between the threshold Th₂ and the threshold Th₁ (NO), then the processing returns to the step 101 to repeat the processing.

Returning to the step 102, if the setting timer is in operation (YES), then the motion analysis unit 311 judges whether the absolute value of the angular velocity AV(Z) or AV(X) is more than or equal to the threshold Th₁ (S108). If both or one of the absolute values of the angular velocities VA(Z) and AV(X) is more than or equal to the threshold Th₁ (YES), then the processing proceeds to the step 109. If both absolute values of the angular velocities are less than the threshold Th₁ (NO), then the processing returns to the step 101 to repeat the processing.

In the step 109, the motion analysis unit 311 generates set direction information that indicates the direction in which an angular velocity more than or equal to the threshold Th₁ has been detected in the step 108 (for example, the rightward direction for Z+, the leftward direction for Z−, the upward direction for X−, or the downward direction for X+), and stores the generated set direction information in the set direction information storage area of the directional information storage area 322.

Next, the motion analysis unit 311 requests the time measuring unit 312 to stop the setting timer and to start the screen switching timer (S110), outputs the angular velocities AV(Z) and AV(X) to the signal control unit 313 to start the screen switching process (S111), and ends the processing. Receiving the setting timer stop request and the screen switching timer start request, the time measuring unit 312 stops the setting timer in operation and starts the screen switching timer. When the screen switching timer ends its operation after elapse of the prescribed time, the time measuring unit 312 outputs a screen switching timer end response to the motion analysis unit 311.

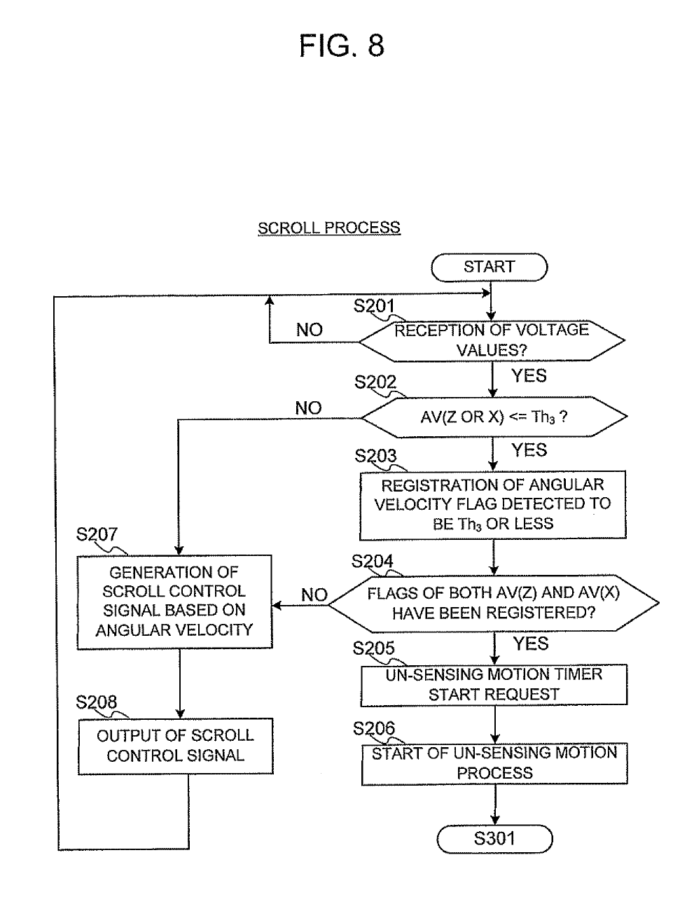

Next, the scroll process will be described. FIG. 8 is a flowchart showing the scroll process performed by the control unit 310.

When the motion analysis unit 311 receives voltage values that are detected by and outputted from the angular velocity sensor (Z) 201A and the angular velocity sensor (X) 201B at prescribed intervals (S201). Then, the motion analysis unit 311 calculates the true variations of the head motion by subtracting the prescribed reference values from the received voltage values, to obtain the angular velocities AV(Z) and AV(X).

Next, the motion analysis unit 311 judges whether the absolute value of the angular velocity AV(Z) or the angular velocity AV(X) is less than or equal to the threshold Th₃ (S202). If both absolute values of the angular velocities are more than the threshold Th3 (NO), then the motion analysis unit 311 outputs the angular velocities AV(Z) and AV(X) to the signal control unit 313, and the processing proceeds to the stop 207. If both or one of absolute values of the angular velocities is less than or equal to the threshold Th₃ (YES), then the processing proceeds to the step 203.

In the step 203, the motion analysis unit 311 generates flag information 700 and stores the generated flag information in the storage area 321. Further, as for the angular velocity that was found to be less than or equal to the threshold Th₃ in the step 202, the motion analysis unit 311 registers a flag that indicates detection of a value less than or equal to the threshold Th₃ in the AV(Z) flag storage area 700a or the AV(X) flag storage area 700b of the flag information 700.

In the step 204, the motion analysis unit 311 reads the flag information from the flag information storage area 321 of the storage unit 320, and detects whether flags are registered in the AV(Z) flag storage area 700a and the AV(X) flag storage area 700b, i.e. whether both rotation angles have become less than or equal to the threshold Th₃ or not. If information indicating both rotation angles is stored (YES), the processing proceeds to the step 205. If information indicating only one rotation angle is stored (NO), the motion analysis unit outputs only the angular velocity that is not stored to the signal control unit 313, and the processing proceeds to the step 207.

In the step 205, the motion analysis unit 311 requests the time measuring unit 312 to start the un-sensing motion timer and starts the un-sensing motion process (S206), and ends the processing, Receiving the un-sensing motion timer start request, the time measuring unit 312 starts the un-sensing motion timer. When the un-sensing motion timer ends its operation after elapse of the prescribed time, the time measuring unit 312 outputs an un-sensing motion timer end response to the motion analysis unit 311.

In the step 207, on receiving the angular velocities or velocity outputted in the step 202 or 204, the signal control unit 313 generates, on the basis of the received angular velocities or velocity, a scroll control signal indicating the direction, distance or the like of scroll. Then, the signal control unit 313 outputs the generated scroll control signal to the display unit 160 (S208), and the processing returns to the step 201.

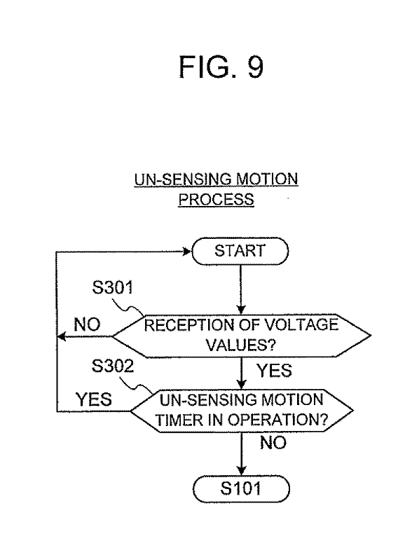

Next, the un-sensing motion process will be described. FIG. 9 is a flowchart showing the un-sensing motion process performed by the control unit 310.

The motion analysis unit 311 receives voltage values that are detected by and outputted from the angular velocity sensor (Z) 201A and the angular velocity sensor (X) 201B at the prescribed intervals (S301).

Next, the motion analysis unit 311 detects whether the un-sensing motion timer of the time measuring unit 312 is in operation or not (S302). If the un-sensing motion timer is in operation (YES), the processing relating to the received voltage values is not performed, and the processing returns to the step 301 to repeat the processing. If the un-sensing motion timer is not in operation (NO), the un-sensing motion process is ended, and the processing returns to the step 101 in FIG. 7 to repeat the processing.

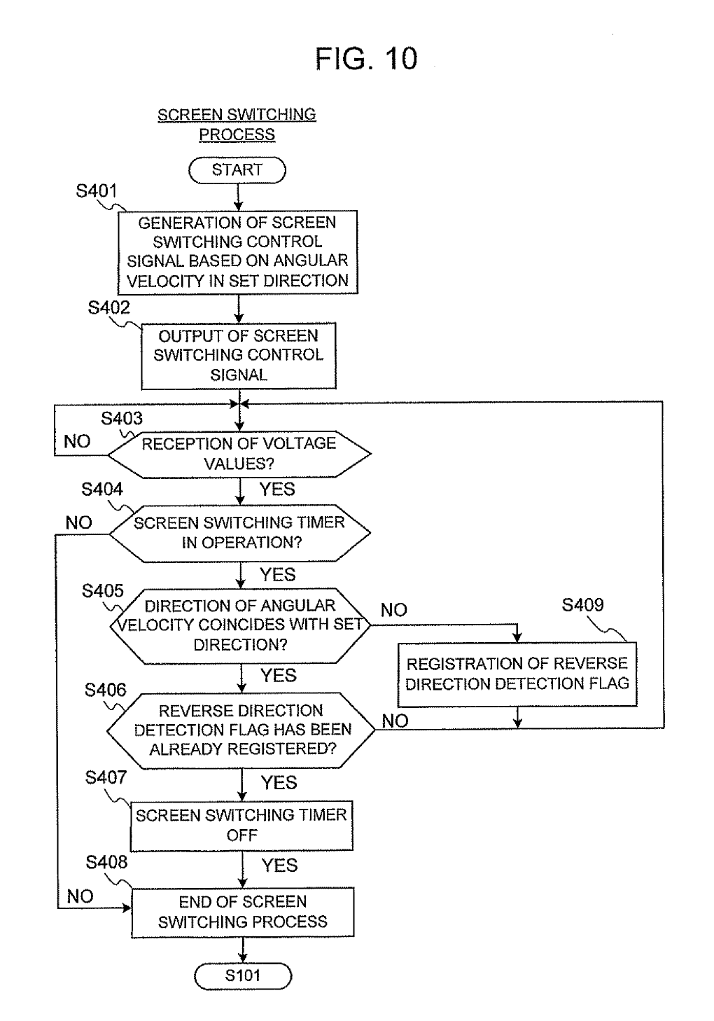

Next, the screen switching process will be described. FIG. 10 is a flowchart showing the screen switching process performed by the control unit 310.

In the step 401, on receiving the angular velocities outputted from the motion analysis unit 311 in the step 111, the signal control unit 313 generates, on the basis of the received angular velocities, a screen switching control signal indicating the screen switching direction and the like. Then, the signal control unit 313 outputs the generated screen switching control signal to the display unit 160 (S402).

Next, the motion analysis unit 311 receives voltage values that are detected by and outputted from the angular velocity sensor (Z) 201A and the angular velocity sensor (X) 201B at the prescribed intervals (8403). Then, the motion analysis unit 311 calculates the true variations of the head motion by subtracting the prescribed reference values from the received voltage values, to obtains the angular velocities AV(Z) and AV(X).

Next, the motion analysis unit 311 detects whether the screen switching timer of the time measuring unit 312 is in operation or not (S404). If the screen switching timer is in operation (YES), the processing proceeds to the step 405. If the screen switching timer is not in operation (NO), the motion analysis unit 311 ends the screen switching process (S408), and the processing returns to the step 101 in FIG. 7 to repeat the processing.

In the step 406, the motion analysis unit 311 reads the set direction information from the set direction information storage area 701a of the directional information storage area 322, and judges whether the direction of the angular velocity AV(Z) or AV(X) coincides with the set direction or not. If the direction of the angular velocity coincides, the processing proceeds to the step 406. Otherwise, the processing proceeds to the step 409.

In the step 406, the motion analysis unit 311 reads the directional information 701 from the directional information storage area 322, and detects whether the reverse direction detection flag is registered in the reverse direction detection flag storage area 701b. If the reverse direction detection flag is registered (YES), the processing proceeds to the step 407. Otherwise (NO), the processing returns to the step 403 to repeat the processing.

In the step 407, the motion analysis unit 311 requests the time measuring unit 312 to stop the screen switching timer. On receiving the screen switching timer stop request from the motion analysis unit 311, the time measuring unit 312 stops the screen switching timer, and outputs a screen switching timer end response to the motion analysis unit 311. On receiving the screen switching timer end response, the motion analysis unit 311 ends the screen switching process (S408).

In the step 409, the motion analysis unit 311 registers the reverse direction detection flag in the reverse direction detection flag storage area 701b of the directional information 701, and the processing returns to the step 403 to repeat the processing.

Having the above-described arrangement, the HMD 101 of the present embodiment can switch processes appropriately according to the magnitude of angular velocity obtained by detecting a user's head motion in one direction. It is possible to use the scroll process and the screen switching process distinguishably between them based on user's head motion (velocity) in one direction. Further, since the un-sensing motion period exists after the scroll process, and since angular velocity in the other direction than the set direction is not reflected in the control during the screen switching process, it is possible to avoid execution of unintended processing owing to a return motion of the head (i.e. a motion of facing the front) or its recoil.

Further, in the processing of the step 106, it may be arranged that, when the absolute value of the angular velocity AV(Z) or AV(X) is less than the threshold Th₁ (AV(Z or X)<Th₁), the processing proceeds to the step 107 where the motion analysis unit 311 performs the scroll process.

Further, it is possible to arrange that, when the absolute values of the angular velocities AV(Z) and AV(X) become less than the threshold Th₂ while the setting timer is operating, the motion analysis unit 311 does not perform the scroll process without regard for a timer end response that is sent from the time measuring unit 312 at the ending of the setting timer currently in operation. According to this arrangement, it is possible to prevent malfunction without performing the scroll process when the user's head motion becomes small in the period between T₁ and T₂.

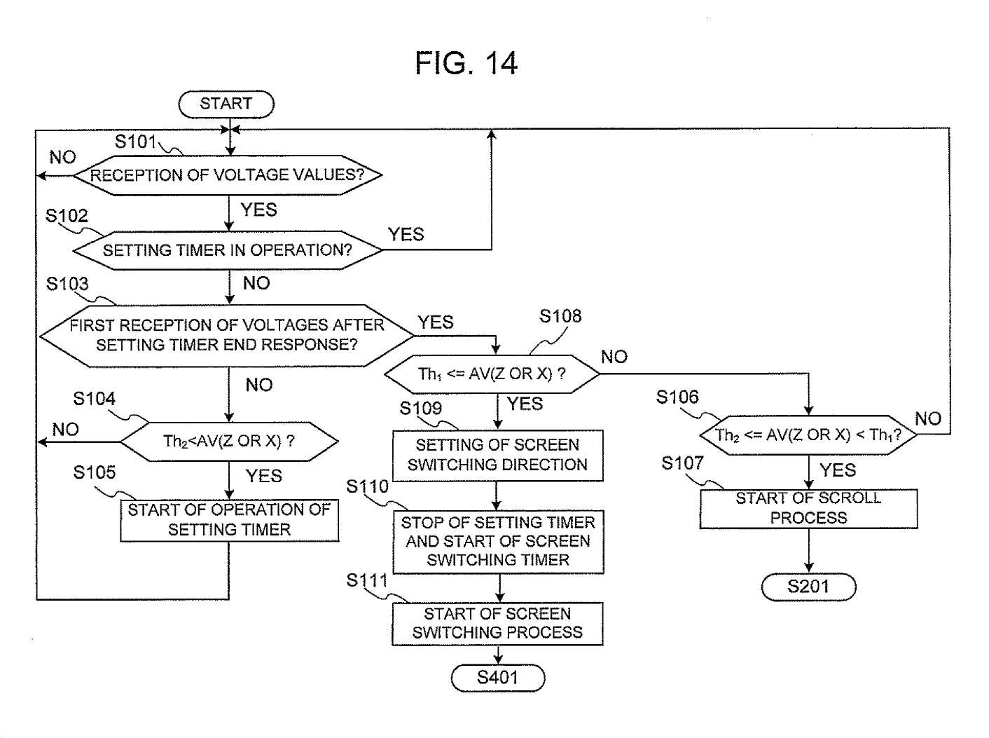

Further, as shown in FIG. 14, it is possible to judge starts of the scroll process and the screen switching process on the basis of the magnitudes of voltage values when the voltage values are first received after an end response of the setting timer is sent. Further, it is possible to arrange that the absolute values of the angular velocities AV(Z) and AV(X) become less than the threshold Th₂ while the setting timer is operating, and when the absolute values of the angular velocities AV(Z) and AV(X) become less than the threshold Th₁ in the step 108 (NO), the processing not proceeds to the step 106 but returns to the step 101 to repeat the processing.

Further, by setting the thresholds Th₃ and Th₄ for the scroll process and the screen switching process to values in the neighborhood of 0°/s, it is possible to detect a small angular velocity of a head motion in the course of each process and to reflect the detected angular velocity in the processing.

Further, it is possible to judge additionally in the step 106 of FIG. 7 whether AV(X) or AV(Z) is an angular velocity in the direction reverse to the direction of the angular velocity that was judged to be more than or equal to Th₂ in the step 104. And, it is possible to arrange that the angular velocity in question is not used if the direction is reverse. In this case, it is favorable to store, in the storage unit, the direction of the angular velocity that is more than or equal to Th₂ in the step 104. Such arrangement can prevent malfunction owing to rapid change in head motion.

Further, Th₃ may be set to 0°/s, and similarly to the step 405 in FIG. 10 the un-sensing motion process may be started when angular velocity reverse to the set direction is detected. Also, Th4 may be set to a value in the neighborhood of 0°/s, and similarly to the step 202 in FIG. 8 the absolute value of angular velocity may be configured to be compared with Th₄.

The processes started in the steps 107 and 111 in FIG. 7 are not limited to the above-described ones. It is possible to start another process executed through a menu screen, game operation or the like.

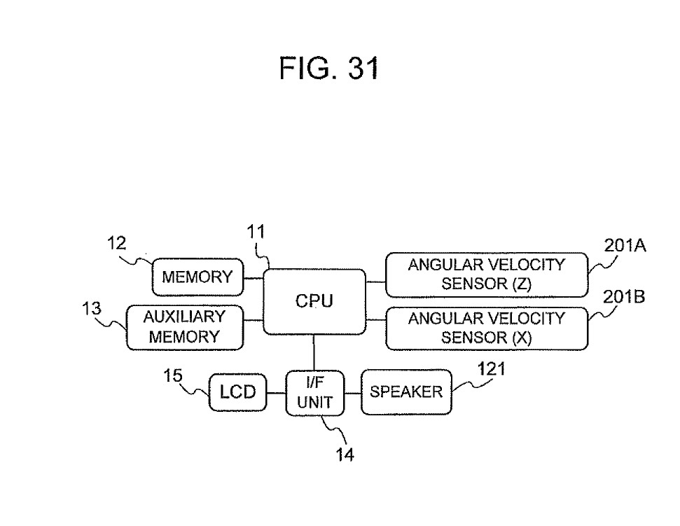

Here, a hardware configuration of the HMD 101 will be described. FIG. 31 is a block diagram showing an electrical configuration of the HMD 101.

As shown in FIG. 31, the HMD 101 comprises: a Central Processing Unit (CPU) 11 for central controlling of devices; a memory 12 for storing various kinds of data in a rewritable way; a nonvolatile auxiliary memory 13 for storing various programs and data or the like generated by the programs; and an I/F unit 14 connecting various devices such as an LCD 15, a speaker 121 and the like to the CPU 11. The control unit 310 can be implemented when a predetermined program stored in the auxiliary memory 13 is read into the memory 12 and executed by the CPU 11, for example.

### Second Embodiment

Next, a second embodiment of the present invention will be described. In the following, an HMD 102 as the second embodiment will be described with respect to different points from the first embodiment.

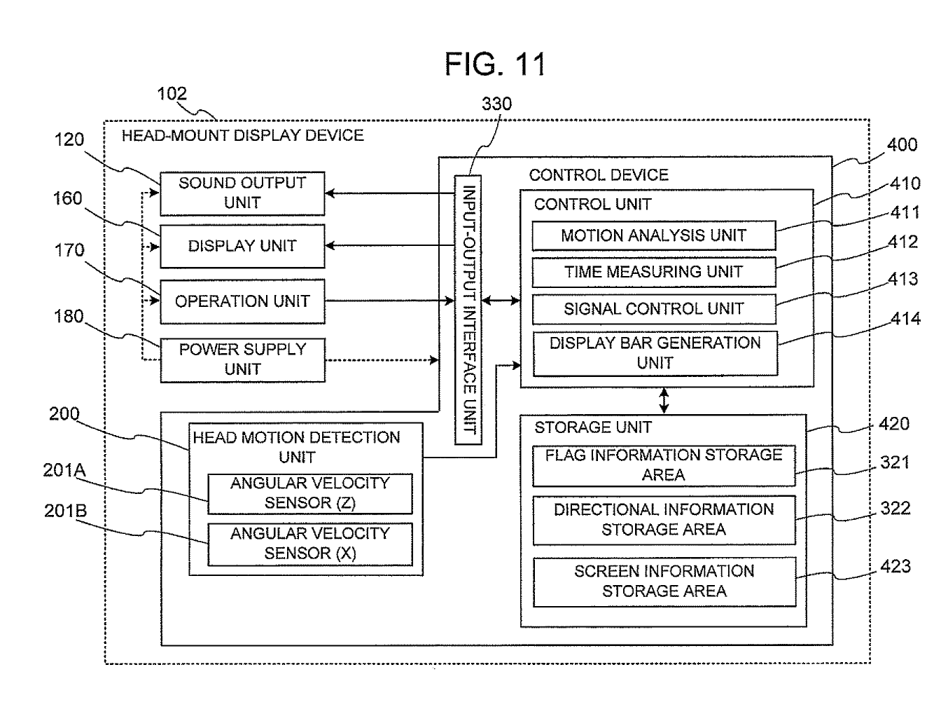

The HMD 102 of the second embodiment of the present invention differs from the first embodiment in that the HMD 102 displays an indicator expressing angular velocities visually. FIG. 11 is a block diagram showing a functional configuration of the HMD 102.

A control unit 410 will be described. The control unit 410 comprises a motion analysis unit 411, a time measuring unit 412, a signal control unit 413, and a display bar generation unit 414.

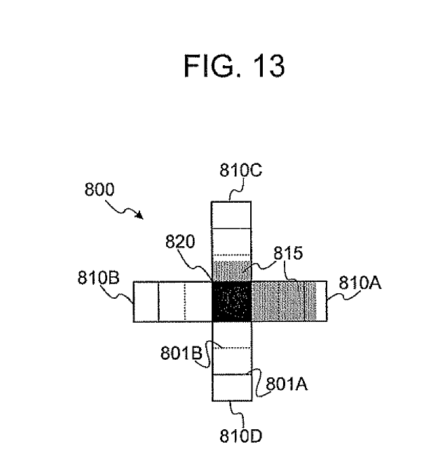

The control unit 410 displays an indicator 800 of a cross shape as shown in FIG. 13 on a screen of a display device provided in a display unit 160.

The indicator 800 is of a cross shape having angular velocity display areas 810A, 810B, 810C and 810D (simply expressed as angular velocity display area 810 when it is not necessary to distinguish them) extending toward four directions. Each area of the indicator 800 has a Th₁ division 801A and a Th₂ division 802B. An angular velocity display bar 815 is displayed being superimposed on each angular velocity display area 810. Further, the central part of the indicator 800 has a processing start notification area 820. Symbol images concerning the indicator 800 have been previously stored in an image storage area 423 of a storage unit 420.

An angular velocity bar 815 is generated by the display bar generation unit 414 based on values of the angular velocities AV(Z) and AV(X) detected by the motion analysis unit 411. In the present invention, the angular velocities are processed into values to be used for displaying, and those values are displayed on the screen by expansion or contraction of the angular velocity display bar 815. The longer the angular velocity display bar 815 is, the higher the angular velocity is (larger motion). And, the shorter the angular velocity display bar 815 is, the lower the angular velocity is.

The angular velocity display areas 810A, 810B, 810C and 810D display the angular velocity display bars 815 of the angular velocity AV(Z+) (rightward motion), the angular velocity AV(Z−) (leftward motion), the angular velocity AV(X−) (upward motion) and the angular velocity AV(X+) (downward motion), respectively.

The motion analysis unit 411 requests the time measuring unit 412 to start operation of the setting timer, and at the same time requests the display bar generation unit 414 to generate the indicator 800. Then, the motion analysis unit 411 outputs, to the display bar generation unit 414, the values of the angular velocities AV(Z) and AV(X) obtained from voltages that are received during operation of the setting timer and received for the first time after termination of the setting timer.

The time measuring unit 412 performs processing similar to that performed by the time measuring unit 312 in the first embodiment, and thus its detailed description is omitted here.

The signal control unit 413 generates an image signal for displaying an image of the indicator 800 outputted from the display bar generation unit 414, to be superimposed upon an image that is currently outputted. Then, the signal control unit 413 outputs the generated image signal to the display unit 160.

Receiving the request for generation of the indicator 800 from the motion analysis unit 411, the display bar generation unit 414 reads the symbol images concerning the indicator 800 from the image storage area 423 of the storage unit 420. Further, based on the angular velocities outputted from the motion analysis unit 411, the display bar generation unit 414 calculates values to be used for displaying, converts the calculated values into angular velocity display bars 815 having the respective corresponding lengths, and outputs the angular velocity bars 815 to the signal control unit 413.

The storage unit 420 comprises a flag information storage area 621, a directional information storage area 622, and the image storage area 423.

The flag information storage area 621 and the directional information storage area 622 store information similar to that stored in the flag information storage area 321 and the directional information storage area 322 of the first embodiment, and thus detailed description of them is omitted here.

The image storage area 423 has previously stored the symbol image information concerning the indicator 800.

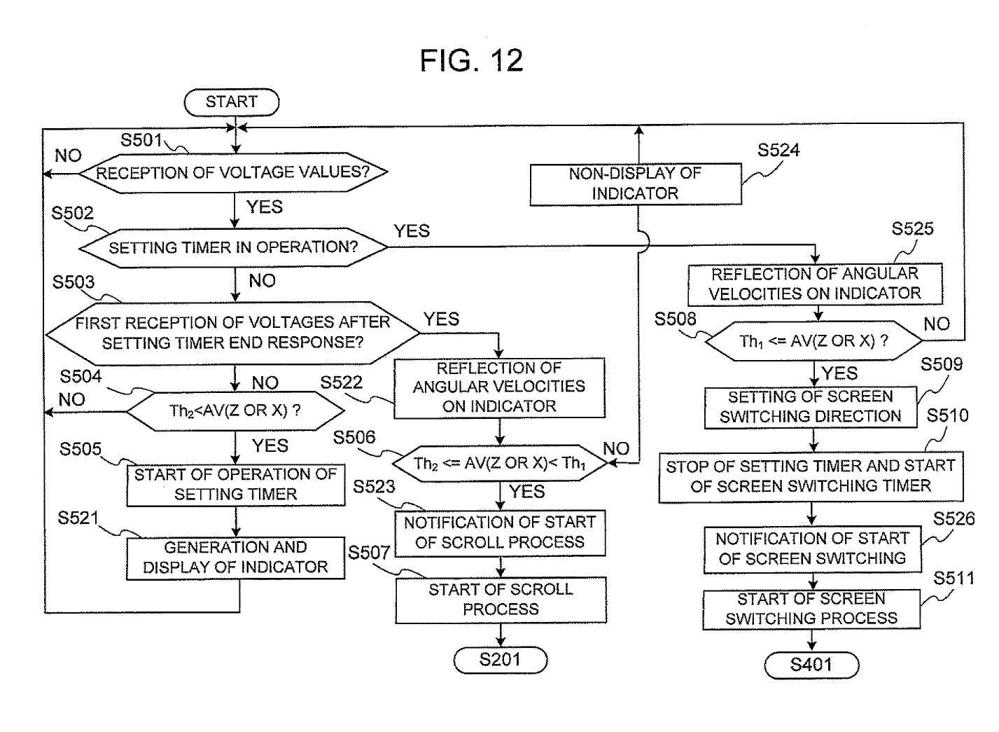

Next, processing performed by the control unit 410 of the HMD 102 of the second embodiment will be described in detail referring to FIG. 12. FIG. 12 is a flowchart showing processing performed when the control unit 410 receives voltage values sent from the head motion detection unit 200.

Processing in the step 501 through the step 511 is similar to the above-described processing in the step 101 through the step 111 performed by the control unit 310 of the HMD 101 of the first embodiment, and its description is omitted here.

In the step 521, the motion analysis unit 411 requests the display bar generation unit 414 to generate the indicator 800 and outputs the current angular velocities AV(Z) and AV(X). On receiving the request for generation of the indicator 800 from the motion analysis unit 411, the display bar generation unit 414 first reads the image information concerning the indicator 800 from the image storage area 423 of the storage unit 420. Further, the display bar generation unit 414 calculates values to be used for displaying on the basis of the angular velocities AV(Z) and AV(X) outputted from the motion analysis unit 411, and generates angular velocity display bars 815 having lengths corresponding to the respective angular velocities. Then, the motion analysis unit 411 outputs the thus-generated indicator 800 to the signal control unit 413.

Receiving the image of the indicator 800 from the display bar generation unit 414, the signal control unit 413 generates an image signal for displaying the indicator 800 being superimposed upon the currently-outputted image, and outputs the generated image signal to the display unit 160.

In the step 522, the motion analysis unit 411 requests the display bar generation unit 414 to generate angular velocity display bars 815, and outputs the current angular velocities AV(Z) and AV(X). Receiving the request for generation of angular velocity display bars 815 from the motion analysis unit 411, the display bar generation unit 414 calculates values to be used for displaying from the angular velocities AV(Z) and AV(X) outputted from the motion analysis unit 411, generates angular velocity display bars 815 having lengths corresponding to the respective angular velocities, and outputs the generated angular velocity display bars 815 to the signal control unit 413.

Receiving the images of the angular velocity display bars 815 from the display bar generation unit 414, the signal control unit 413 generates an image signal for reflecting the angular velocity display bars 815 on the currently-outputted image of the indicator 800, and outputs the generated image signal to the display unit 160.

In the step 506, the motion analysis unit 411 detects whether the absolute value of the angular velocity AV(Z) or AV(X) falls within the range between the threshold Th₂ and the threshold Th₁. If both or one of the absolute values of the two angular velocities falls within the range between the threshold Th₂ and the threshold Th₁ (YES), the processing proceeds to the step 523. If both absolute values of the angular velocities exist outside the range between the threshold Th₂ and the threshold Th₁ (NO), the motion analysis unit 411 requests the signal control unit 413 to hide the image of the indicator 800, and the processing proceeds to the step 524.

In the step 523, the motion analysis unit 411 requests the signal control unit 413 to notify the user that the scroll process is to be started. Receiving the request for notification of the start of the scroll process, the signal control unit 413 first increases the brightness of the processing start notification area 820 to notify the user of the start of the scroll process. Next, the signal control unit 413 stops sending of the image signal of the indicator 800 to the display unit 160, and then the processing proceeds to the step 507, in which the motion analysis unit 411 starts the scroll process.

In the step 524, on receiving the request for non-display of the indicator 800, the signal control unit 413 stops sending of the image signal of the indicator 800 to the display unit 160. Then, the processing returns to the step 501, to repeat the processing.

In the step 525, similarly to the step 522, the motion analysis unit 411 requests the display bar generation unit 414 to generate angular velocity display bars 815, and outputs the current angular velocities AV(Z) and AV(X). Receiving the request for generation of angular velocity display bars 815 from the motion analysis unit 411, the display bar generation unit 414 calculates values to be used for displaying from the angular velocities AV(Z) and AV(X) outputted from the motion analysis unit 411, generates angular velocity display bars 815 having the lengths corresponding to the respective angular velocities, and outputs the generated angular velocity display bars 815 to the signal control unit 413.

Receiving the images of the angular velocity display bars 815 from the display bar generation unit 414, the signal control unit 413 generates an image signal for reflecting the angular velocity display bars 815 on the currently-outputted image of the indicator 800, and outputs the generated image signal to the display unit 160.

In the step 526, the motion analysis unit 411 requests the signal control unit 413 to notify the user that the screen switching process is to be started. Receiving the request for notification of the start of the screen switching process, the signal control unit 413 first outputs a video signal for increasing the brightness of the processing start notification area 820 to the display unit 160 to notify the user of the start of the screen switching process. Next, the signal control unit 413 stops sending of the image signal of the indicator 800 to the display unit 160, and the processing proceeds to the step 511, in which the motion analysis unit 411 starts the screen switching process.

According to the above-described arrangement, the HMD 102 of the present embodiment displays the indicator 800 when the setting timer starts its operation. As a result, the user can visually grasp the angular velocities of the head motion and the thresholds determined for executing various kinds of processing, and can make an appropriate head motion for putting intended processing into action. Further, by notifying start of each kind of processing by light emission of the processing start notification area 820, the user can perform more intuitive operation.

Further, in addition to the light emission of the processing start notification area 820, it is possible to employ setting where a sound signal for producing a notification sound is outputted to the sound output unit 120. Or, start of processing may be notified through a notification sound only.

Further, not to interfere with a background image, the indicator 800 may be a transparent image. Or, it is possible to arrange that the user can select display and non-display of the indicator 800.

Further, it is possible to arrange that the signal control unit 413 can appropriately change a display position of the indicator 800 in the steps 521, 522 and 525. For example, it is possible to judge in front of which of the eyes the display unit 160 is positioned, on the basis of the direction of tilt, setting, and the like of the arm unit 150, in order to display the indicator 800 in a position that does not interrupt viewing of the image (for example, the upper or lower right corner in the case of the right eye, or the upper or lower left corner in the case of the left eye).

### Third Embodiment

Next, a third embodiment of the present invention will be described. An HMD 103 of the present embodiment is also similar to the HMD 101 of the first embodiment, and thus description of the same components will be omitted.

The HMD 103 of the third embodiment of the present invention differs from the HMD of the first embodiment in that corrected coordinates are calculated from the coordinate system for detection by angular velocity sensors and a user's coordinate system.

When the HMD 103 is mounted on the user's head, screen operation concerning the display screen of the display unit 160 can be performed basically when the user moves his head. However, sometimes error occurs owing to user's way of mounting the HMD 103 on his head, user's way of moving his neck out of habit, or the like, and the user cannot always perform intended operation.

Thus, in order to perform accurate operation by user's own head motion, the HMD 103 of the present embodiment performs processing of compensating error occurring from user's way of mounting the HMD 103 on his head, user's way of moving his neck out of habit, and the like.

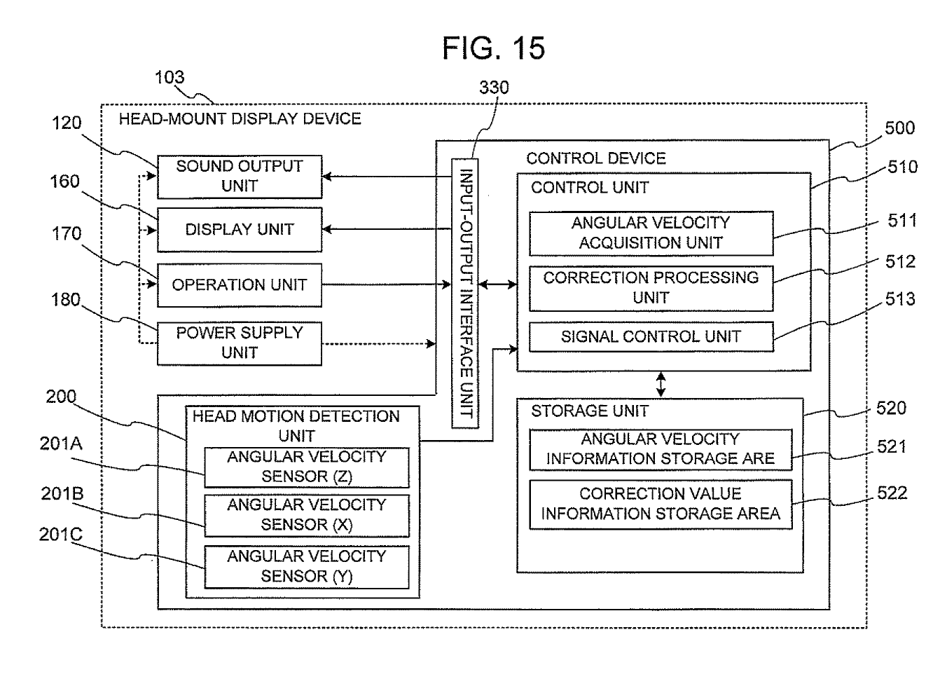

FIG. 15 is a block diagram showing a functional configuration of the HMD 103. In the following, a control unit 500 will be described mainly with respect to different points from the above embodiments.

A head motion detection unit 202 has an angular velocity sensor (Z) 201A, an angular velocity sensor (X) 201B and an angular velocity sensor (Y) 201C (simply referred to by 201 if it is not necessary to distinguish between them), to detect angular velocities in triaxial directions respectively. Here, the angular velocity sensor (Y) 201 detects user's movement of tilting his head (roll angle).

In the following description, angular velocity of rotational motion around the Z-axis, which is detected by the angular velocity sensor (Z) 201A, is written as ωz; angular velocity of rotational motion around the X-axis detected by the angular velocity sensor (X) 201B as ωx; and angular velocity of rotational motion around the Y-axis detected by the angular velocity sensor (Y) 201C as ωy. Further, the user's coordinate system is expressed as XYZ, and the coordinate system of the angular velocity sensors as X′,Y′,Z′.

The control unit 510 comprises: an angular velocity acquisition unit 511 for acquiring time course samples of angular velocity of rotational motion of the head based on the user's XYZ-axes; a correction processing unit 512 for calculating correction values of the coordinate system from the time course of the angular velocity; and a signal control unit 513 for generating and outputting an image signal to output to the display unit 160, a sound signal to output to the sound output unit 120, and the like.

A storage unit 520 comprises an angular velocity information storage area 521 for storing time course samples of angular velocity acquired by the angular velocity acquisition unit 511 and a correction value information storage area 522 for storing correction values calculated by the correction processing unit 512.

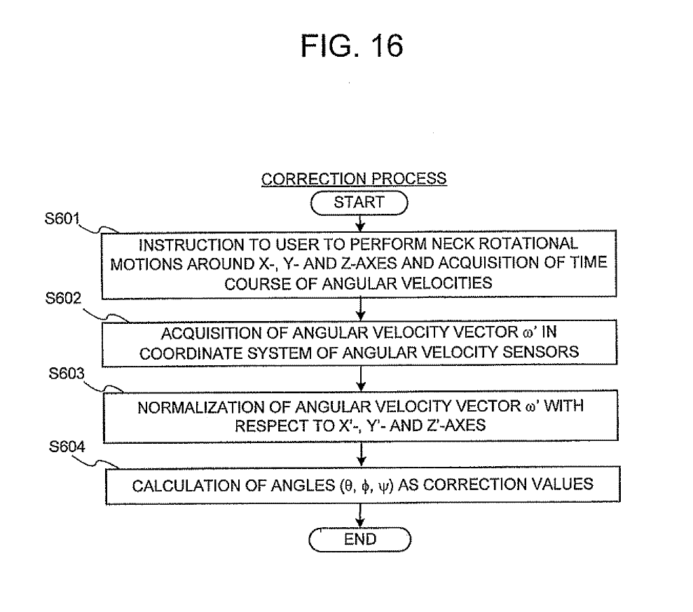

Next, operation performed by the control unit 510 will be described referring to FIG. 16.

The control unit 510 starts the correction process shown in FIG. 16 when, for example, the user turns on a power switch of the HMD 103 and a power supply unit 180 starts supplying electric power to each part. In the present embodiment, it is assumed that the storage unit 520 has previously stored data of image, video, music, or the like.

In the step 601, the angular velocity acquisition unit 511 requests the signal control unit 513 to display a screen for instructing the user to make a rotational motion around the X-axis by moving his neck forward and backward once, and acquires time course samples of angular velocities.

In detail, the angular velocity acquisition unit 511 requests the signal control unit 513 to display the screen for instructing the user to make a rotational motion around the X-axis by moving his neck forward and backward once. The signal control unit 513 displays that screen on the display unit 160. Further, the angular velocity acquisition unit 511 acquires, as samples, angular velocities ωx′, ωy′ and ωn′ of a rotational motion of the user's neck around the X-axis, which are outputted from the angular velocity sensors 201 at a prescribed sampling frequency, and stores the acquired samples in the angular velocity information storage area 521.

Similarly, the angular velocity acquisition unit 511 requests the signal control unit 513 to display on the display unit 160 an instruction screen for instructing the user to make a rotational motion of tilting his neck around the Y-axis and a rotational motion of shaking his neck right and left around the Z-axis, each once. And, the angular velocity acquisition unit 511 registers to the angular velocity information storage area 521 the time course of angular velocities ωx′, ωy′ and ωn′ associated with each motion of the user.

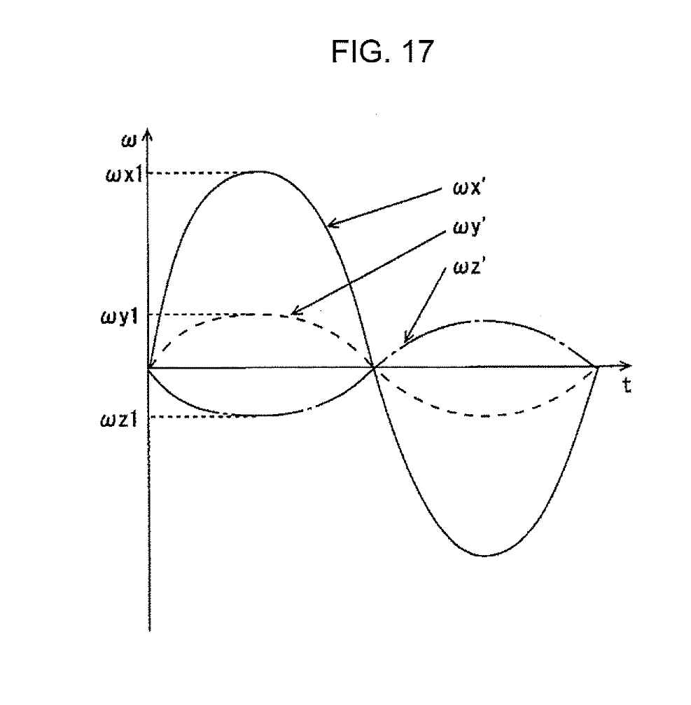

FIG. 17 shows an example of a chart showing time course of the angular velocities acquired as samples based on the user's motion (here, a rotational motion of moving his head forward and backward once around the X-axis). In this chart, the horizontal axis indicates time t, and the vertical axis angular velocity co.

Here, if the HMD 103 was mounted on the user's head such that the user's coordinate system (X, Y, Z) coincided completely with the coordinate system (X′, Y′, Z′) of the angular velocity sensors and the user could move his neck forward and backward around the X-axis, then this chart showing the angular velocity of the samples acquired by the angular velocity acquisition unit 511 should show that only the angular velocity component ωx′ detected by the angular velocity sensor AV(X) 201 has been detected (The present embodiment judges this state as a state where the HMD 103 has been correctly mounted).

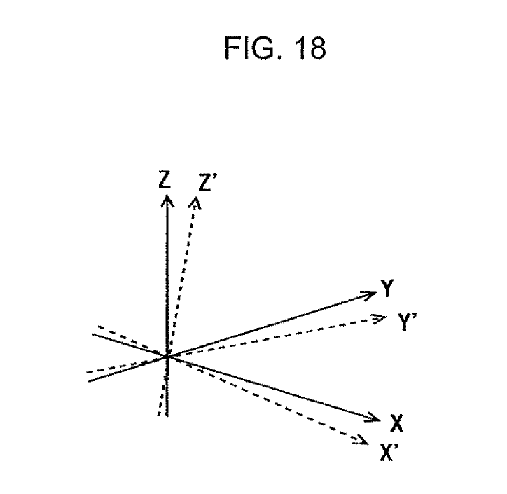

Actually, however, the angular velocity ωy′ and ωz′ have been also detected by the angular velocity sensor (X) 201B and the angular velocity sensor (Y) 201C because the HMD 103 has not been correctly mounted on the user or owing to the user's way of moving his neck out of habit, or the like. This means that, as shown in FIG. 18, there is a difference between the user's coordinate system (X, Y, Z) and the coordinate system (X′, Y′, Z′) of the angular velocity sensors, and these coordinate systems are deviated relative to each other owing to wrong mounting position of the HMD 103 or the user's way of moving out of habit. This difference (error) becomes a cause that the user cannot perform intended operation when he moves his neck to perform screen operation with respect to the screen display on the display unit 160.

Thus, in order to reflect user's intended control on operation even when the HMD 103 is not mounted correctly or the user moves his head in his manneristic way, it is necessary to perform compensation by transforming an angular velocity vector ω′=(ωx′, ωz) detected by the angular velocity sensor (Z) 201A, the angular velocity sensor (X) 201B and the angular velocity sensor (Y) 201C into an angular velocity vector ω=(ωx, ωy, ωz) of the user's coordinate system.

In the case where, as shown in FIG. 18, the user's coordinate system and the coordinate system of the angular velocity sensors are deviated relative to each other by angles (θ, φ, ψ) with respect to the X-, Y- and Z-axes, it is possible to relate the angular velocity vector ω and the angular velocity vector ω′ by the following equation (1) using respective rotating matrices for the X-, Y- and Z-axes shown in the equation (2).

$$\begin{matrix}ω = Rx ( θ ) Ry ( φ ) Rz ( ψ ) {ω}^{′} & ( 1 ) \\ Rx ( θ ) = ( \begin{matrix}1 & 0 & 0 \\ 0 & cos ( θ ) & sin ( θ ) \\ 0 & - sin ( θ ) & cos ( θ )\end{matrix} ) \\ Ry ( φ ) = ( \begin{matrix}cos ( φ ) & 0 & - sin ( φ ) \\ 0 & 1 & 0 \\ sin ( φ ) & 0 & cos ( φ )\end{matrix} ) \\ Rz ( ψ ) = ( \begin{matrix}cos ( ψ ) & sin ( ψ ) & 0 \\ - sin ( ψ ) & cos ( ψ ) & 0 \\ 0 & 0 & 1\end{matrix} ) & ( 2 )\end{matrix}$$

Thus, in the following steps, the correction processing unit 512 applies the angular velocities acquired as samples of a rotational motion of the head with respect to the X-, Y- and Z-axes to the equations (1) and (2), to acquire angles (θ, φ, ψ) as correction values.

In the step 602, the correction processing unit 512 extracts, from the angular velocity data acquired as the samples, angular velocities relating to the respective axes at the time when the angular velocity of the direction relating to the axis of the user's rotational motion becomes maximum. For example, in the case of a rotational motion of the neck around the X-axis as shown in FIG. 4, the angular velocities ωx1, ωy1 and ωz1 at the time when the absolute value of ωx′ becomes maximum are extracted out of time course of the detected angular velocities ωx′, ωy′ and ωn′, and these extracted angular velocities ωx1, ωy1 and ωz1 constitute an angular velocity vector ω′ in the coordinate system of the angular velocity sensors for a rotational motion of the neck around the X-axis. Similarly, an angular velocity vector ω′ is extracted from angular velocity data resulted from rotational motion of neck around each of the Y-axis and the Z-axis.

In the step 603, the correction processing unit 512 normalizes the angular velocity vector ω′ extracted in the step 102 in relation to each of the Y′- and Z′-axes. This is because, for example in the case of a rotational motion of the neck around the X-axis, an angular velocity vector ω in the user's coordinate system. XYZ has only the X component, and should be (1, 0, 0) for example. The same is true with respect to an angular velocity vector ω of a rotational motion of the neck around the Y- or Z-axis. Thus, the extracted three angular velocity vectors w′ are normalized respectively.

In the step 604, the correction processing unit 512 substitutes the angular velocity vector ω′ (normalized in the step 103) with respect to each of the X′-, Y′- and Z′ axes and the angular velocity vector ω in the user's coordinate system XYZ into the equation (1), and obtains the angles (θ, φ, ψ) by using, for example, the least squares method. Then, the correction processing unit 512 stores the obtained angles (θ, φ, ψ) as correction values in the correction value information storage area 522, and ends the processing.

Thus, by transforming the angular velocities ωx′, ωy′ and ωn′ of a user's head motion detected by the angular velocity sensor (Z) 201A, the angular velocity sensor (X) 201B and the angular velocity sensor (Y) 201C into an angular velocity vector ω in the user's coordinate system using the obtained angles (0, 0), \y) together with the equations (1) and (2), the user can accurately perform screen operation relating to screen display on the display unit 160 by moving his head even when the HMD 103 is not correctly mounted and the user moves his neck in the manneristic way.

Thus, the user can view and listen to image, video, music and the like presented through the display unit 160 and perform various kinds of setting of the HMD 103 without worrying about the mounting state of the HMD 103 and his habit.

Thus, according to the present embodiment, by previously making the user perform a rotational motion around each of the X-, Y- and Z-axes and performing process of obtaining correction values, it is possible to perform accurate screen operation to screen display on the display unit 160 by Moving the user's head, even when the HMD 103 is mounted incorrectly on the user's head and the user moves his neck out of habit.

Further, the correction processing of the present embodiment can be performed using only the angular velocity sensors that can measure angular velocities relating to triaxial directions, and carrying out only simple calculation of the equations (1) and (2). Thus, high speed processing can be realized and cost can be reduced without enlarging the scale of circuit.

### Fourth Embodiment

Next, an HMD 104 according to a fourth embodiment of the present invention will be described. The HMD 104 of the present embodiment of the invention is basically similar to the HMD 103 of the third embodiment, and description of operation of each component will be omitted.

The HMD 104 of the present embodiment differs from the HMD of the third embodiment in that, if one of obtained angles (θ, φ, ψ) is larger than or equal to a threshold, a warning unit 614 requests a signal control unit 513 to make a sound output unit 120 to output a warning sound such as a beep sound, to make the user to mount the HMD 104 once again, instead of using the obtained angles (θ, φ, ψ) for correcting angular velocities detected by angular velocity sensors.

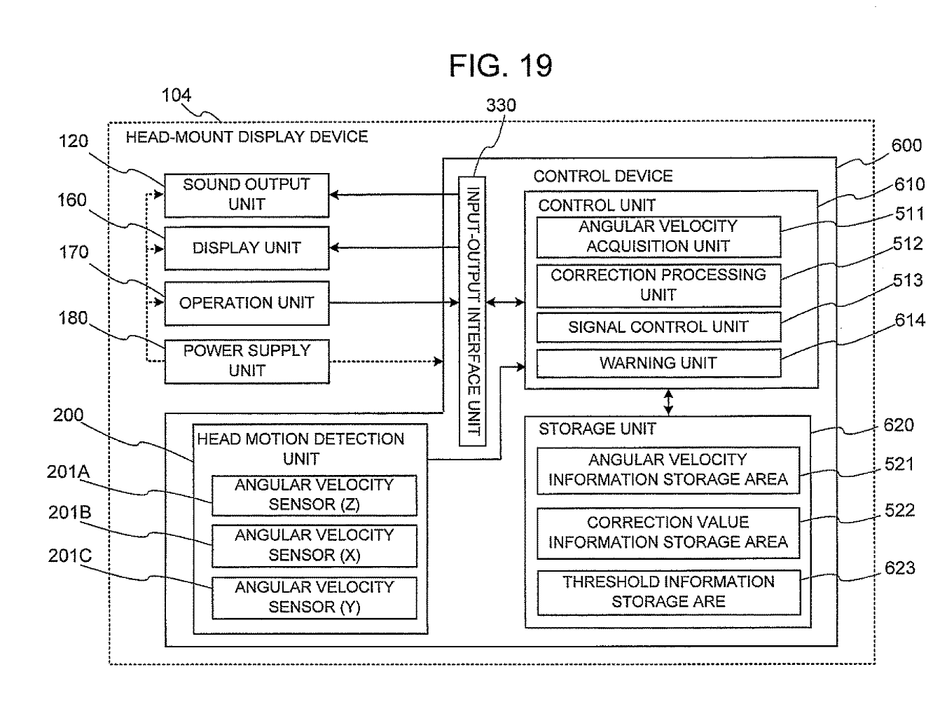

FIG. 19 is a block diagram showing a functional configuration of the HMD 104. In the following, a control device 600 will be described mainly with respect to different points from the above embodiments.

Similarly to the control unit 510 of the third embodiment, a control unit 610 comprises an angular velocity acquisition unit 511, a correction processing unit 512, and a signal control unit 513. In addition, the control unit 610 of the present embodiment further comprises the warning unit 614 that judges whether the HMD 104 is correctly mounted and issues a warning to the user when the HMD 104 is not correctly mounted.

Similarly to the storage unit 520 of the third embodiment, a storage unit 620 comprises an angular velocity information storage area 521 for storing time course samples of angular velocity acquired by the angular velocity acquisition unit 511 and a correction value information storage area 522 for storing correction values calculated by the correction processing unit 512. The storage unit 620 further comprises a threshold information storage area 623 for storing threshold information that is used for deciding whether the warning unit 614 gives a warning. Further, it is assumed that the storage unit 620 stores the warning sound, a warning screen and the like used at the time of giving a warning.

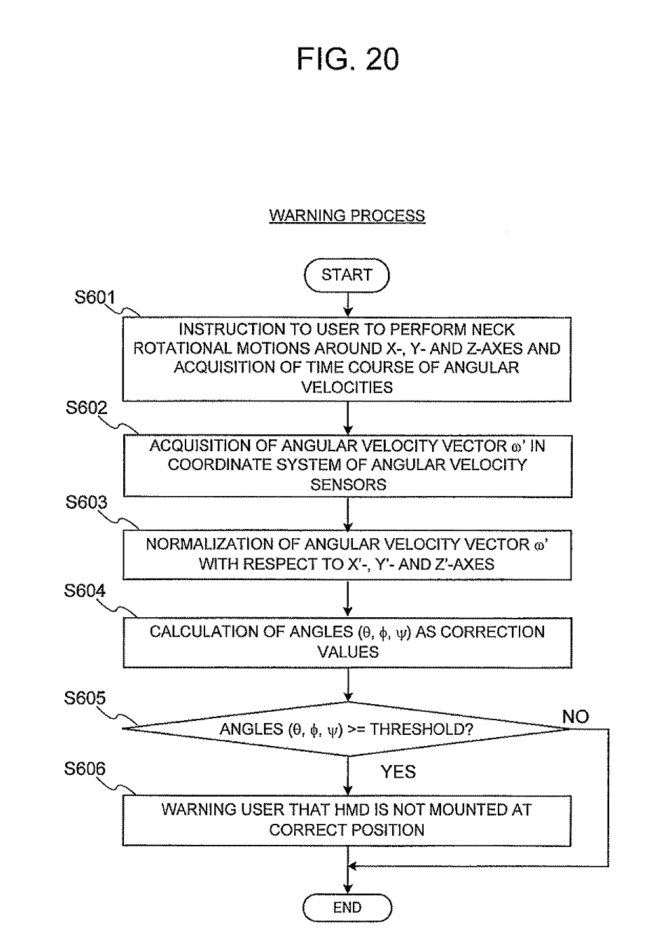

FIG. 20 is a flowchart showing processing performed in the HMD 104 of the present embodiment.

Similarly to the third embodiment, the control unit 610 starts the correction processing shown in FIG. 20 when, for example, the user turns on a power switch of the HMD 104 and a power supply unit 180 starts supplying electric power to each part. In the present embodiment also, it is assumed that the storage unit 620 has previously stored data of image, video, music or the like.

Processing in the step 601 through the step 604 is similar to the third embodiment, and its detailed description is omitted here.

In the step 605, the warning unit 614 judges whether one of the angles (θ, φ, ψ) calculated by the correction processing unit 512 is more than or equal to the threshold stored in the threshold information storage area 623. If the value of one of the obtained angles (θ, φ, ψ) is more than or equal to the threshold, the warning unit 614 judges that the HMD 104 is not correctly mounted, and the processing proceeds to the step 606 (YES side). On the other hand, if the values of the obtained angles (θ, φ, ψ) are less than the threshold, the warning unit 614 judges that the HMD 104 is correctly mounted, and ends the work (NO side).

As the threshold (for example 5°, −10°) stored in the threshold information storage area 623, a different value may be set for each of θ, φ and ψ.

In the step 606, the warning unit 614 requests the signal control unit 513 to start warning. As the warning, a warning sound such as a beep sound is issued through a sound output unit 120 in order to inform the user that the HMD 104 is not correctly mounted. At the same time, the warning unit 614 generates a warning screen for displaying the axial direction for which the angle concerned became more than or equal to the threshold and the value of the angle, and then the warning unit 614 outputs a display request to the signal control unit 513. The signal control unit 513 makes the display unit 160 display the warning screen, to prompt the user to mount again the HMD 104 in the correct position. Thereafter, the control unit 610 ends a series of works.

Thus, by comparing the obtained angles (θ, φ, ψ) with the threshold, the HMD 104 of the present embodiment can make the user mount the HMD 104 in the correct position, so that the user can perform accurate screen operation to screen display on the display unit 160 by moving his head. As a result, the user can view and listen to image, video, music and the like presented through the display unit 160 and perform various kinds of setting of the HMD 104 without worrying about the mounting state of the HMD 104 and his habit.

Thus, according to the present embodiment, when the control unit 610 performs processing of obtaining the angles (θ, φ, ψ) by previously making the user perform a rotational motion of his neck around each of the X-, Y- and Z-axes, it is possible to perform accurate screen operation to screen display on the display unit 160 by moving the user's head, even when the user's neck is moved in the manneristic way. This is because the user is prompted to mount the HMD 104 again if the HMD 104 is mounted incorrectly mounted on the user's head.

Further, the correction processing of the present embodiment can be performed by using angular velocity sensors that can measure angular velocities relating to triaxial directions and carrying out only simple calculation of the equations (1) and (2). As a result, high speed processing can be realized and at the same time cost can be reduced without enlarging the scale of circuit.

In the third, fourth and other embodiments, the user is made to perform a rotational motion of his neck once around each of the X-, Y- and Z-axes at the time when the HMD is mounted on the user, in order to obtain the angles (θ, φ, ψ) used for correcting a difference between the coordinate system of the angular velocity sensors and the user's coordinate system. However, the present invention is not limited to this. For example, it is possible that the user is made to perform a plurality of rotational motions of the neck. In that case, it is possible to obtain more angular velocity vectors ω′ relating to each of the X-, Y′- and Z′-axes, and the angles (θ, φ, ψ) obtained by the least squares method become more accurate.

Further, even after obtaining the angles (θ, φ, ψ), it is possible to detect angular velocities ωx′, ωy′ and ωz′ of a user's head motion that is made for example as a “YES” or “NO” response to a screen displayed on the display unit 160. By using these angular velocities together with the three angular velocity vectors ω′ obtained at the time of mounting of the HMD, the values of the angles (θ, φ, ψ) can be updated to improve their accuracies.

Further, depending on conditions, it is possible to omit the correction processing based on a user's rotational motion around each of the X-, Y- and Z-axes performed at the time of mounting. In that case, the angles (θ, φ, ψ) can be obtained or updated by using only angular velocities of a user's motion of his neck detected by the respective angular velocity sensors at the time of a response of, for example, “YES” (rotational motion around the X-axis) or “NO” (rotational motion around the Z-axis) to a screen displayed on the display unit 160 in the course of use of the HMD.

In the step 602, the angular velocities ωx′, ωy′ and ωz′ at the time when the angular velocity of a rotational motion of the neck around each of the X-, Y- and Z-axes becomes maximum are extracted from the data of angular velocities detected by the angular velocity sensors in order to obtain the angles (θ, φ, ψ). However, the present invention is not limited to this. In fact, ratios between values of angular velocities detected by the angular velocity sensor (Z) 201A, the angular velocity sensor (X) 201B and the angular velocity sensor (Y) 201C are almost constant regardless of time t. For this reason, angular velocities ωx′, ωy′ and ωz′ relating to the respective X′-, Y′- and Z′-axes obtained at any time t can be used to have an angular velocity vector ω′ in the coordinate system of the gyro sensors.

In the third and fourth embodiments, the user is made to make a rotational motion around each of the X-, Y- and Z-axes. However, the present invention is not limited to this, and the angles (θ, φ, ψ) can be obtained if it is possible to obtain angular velocity data of at least two axes among the X-, Y- and Z-axes.

Further, the present invention can be applied even to the case where, among three gyros of a gyro sensor, a gyro sensor for one axis does not exist.

In the third and fourth embodiments, the rotating matrices of the equation (2) are used as respective rotating matrices for the X-, Y- and Z-axes. However, if a value of the angles (θ, φ, ψ) is small, calculation may be made by approximating, for example, cos θ by 1 and sin θ by θ. In this case, the unit of angle is radian. Also as for φ and ψ, approximation similar to the case of the angle θ can be employed.

In the third embodiment, the obtained angles (θ, φ, ψ) are simply stored in the storage unit. However, the present invention is not limited to this. It is possible to store angles (θ, φ, ψ) as correction values for each user. In that case, a user who uses the HMD can read his angles (θ, φ, ψ) by screen operation to screen display on the display unit 160 at the time of mounting the HMD by that user, to omit the correction processing to be performed at the time of mounting the HMD.

### Fifth Embodiment

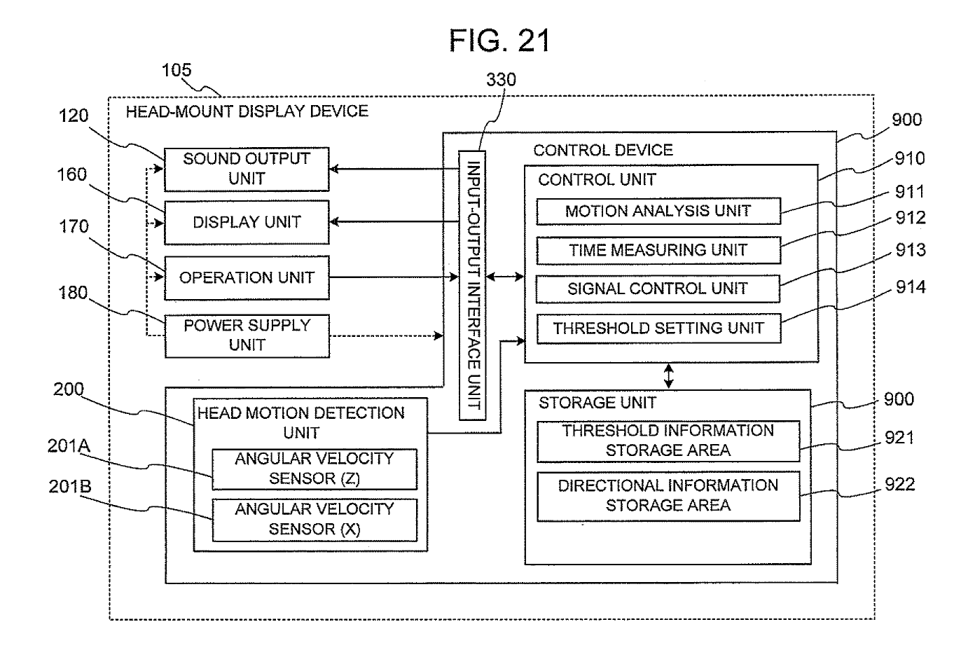

Next, an HMD 105 according to a fifth embodiment of the present invention will be described referring to FIG. 21. The HMD 105 of the present embodiment has a basically-similar configuration to that of the HMD 101 of the first embodiment. However, in the HMD 105 of the present embodiment, it is possible to determine appropriately the thresholds used for making a judgment, based on a user's motion, on whether processing is to be performed or not.

FIG. 21 is a block diagram showing a functional configuration of the HMD 105.

A control device 900 will be described with respect to different points in comparison with the first embodiment. First, a control unit 910 of the present embodiment will be described. The control unit 910 comprises a motion analysis unit 911, a time measuring unit 912, a signal control unit 913, and a threshold setting unit 914.

The motion analysis unit 911 receives voltage values outputted from an angular velocity sensor (Z) 201A and an angular velocity sensor (X) 201B at each prescribed point of time. Then, the motion analysis unit 911 calculates angular velocities AV(Z) and AV(X) of the head motion from those voltage values and prescribed reference values that have been previously generated, and performs processing corresponding to the calculated angular velocities. The motion analysis unit 911 performs each kind of processing while accumulating a history of detected angular velocities in a storage unit 920. It is sufficient that storing of the history of angular velocities is performed for each set of angular velocities corresponding to one period ranging from swinging of the head toward one direction to returning of the head.

The present embodiment will be described with respect to the case where processing corresponding to angular velocities is a screen switching process. However, processing to be performed is not limited to this kind, and the present invention can be applied to any kind of processing such as changing of sound volume or sound field, scroll process, operation of a game, or the like.

The time measuring unit 912 has a timer (not shown) for measuring a time relating to user's head motion. On receiving a timer start request from the motion analysis unit 911, the time measuring unit 912 starts operation of the timer. Then, after elapse of a prescribed time, the time measuring unit 912 stops the timer and resets its measured value.

The signal control unit 913 generates and outputs a control signal corresponding to a head motion such as an image signal to be outputted to the display unit 160, a sound signal to be outputted to the sound output unit 120, or the like. Similarly, the signal control unit 913 also performs processing of generation and output of a signal corresponding to a user's instruction received through the operation unit 170.

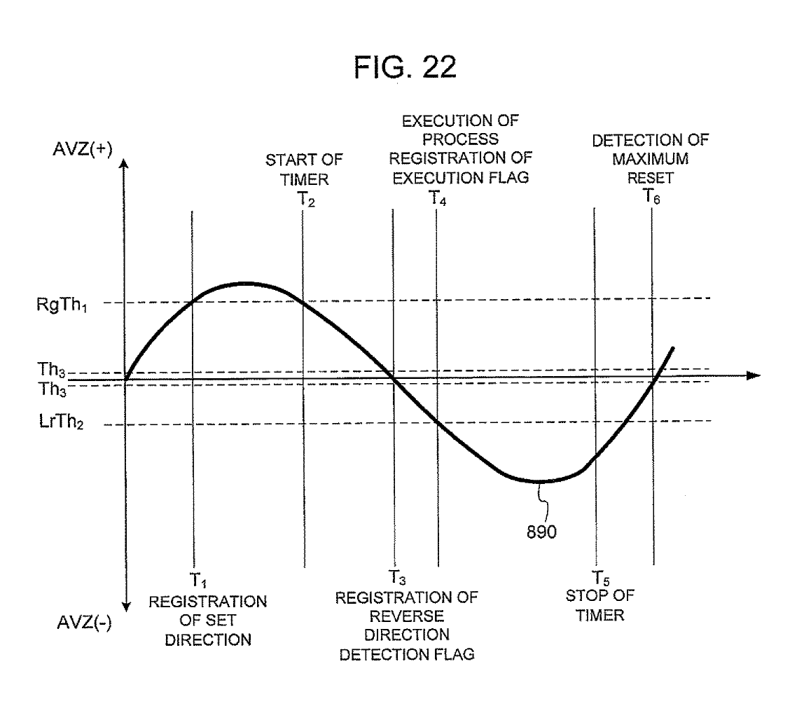

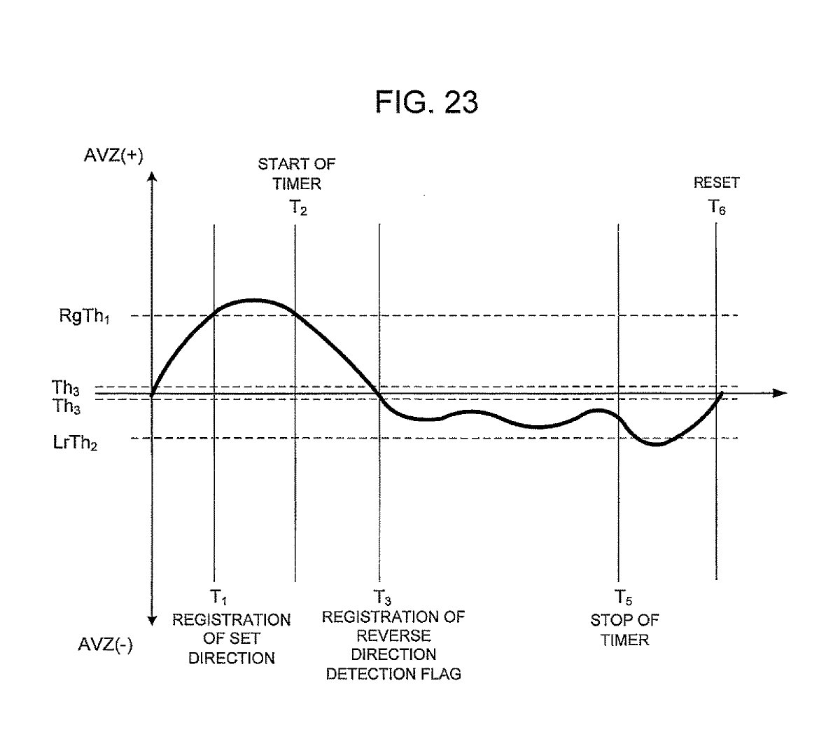

Next, processing performed by the control unit 910 will be described in detail referring to FIGS. 22-26. FIG. 22 is a chart showing time course of angular velocity of head motion when the control unit 910 performs the scroll process, and FIG. 23 is a chart showing time course of angular velocity of head motion when the control unit 910 performs the screen switching process.

In FIG. 22, the horizontal axis indicates time and the vertical axis indicates angular velocity. Further, coordinates on the upper side of the horizontal axis form an area indicating angular velocities in the rightward direction, and coordinates on the lower side of the horizontal axis form an area indicating angular velocities in the leftward direction. Here, the curve 890 indicating change in angular velocity shows time course of angular velocity AV(Z±) detected when a user's head motion is a rightward swing.

A threshold RgTh₁ is the absolute value of angular velocity required for instructing rightward screen switching operation, and a threshold LrTh₂ is the absolute value of angular velocity required when the motion analysis unit 911 actually performs the rightward screen switching. These thresholds have been previously stored in a threshold information storage area 921 of the storage unit 920.

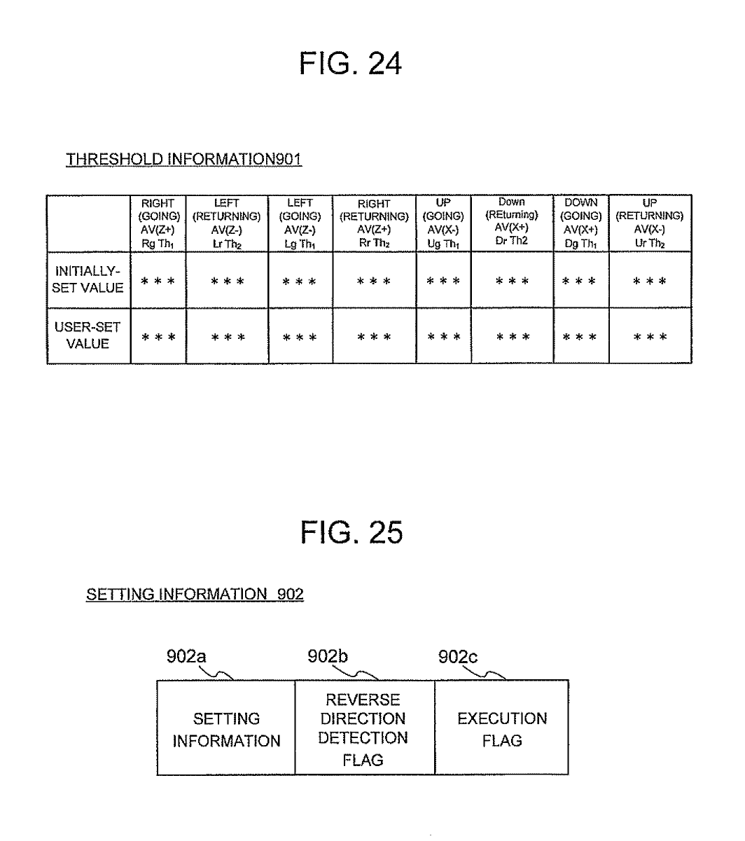

Here, threshold information 901 stored in the threshold information storage area 921 will be described referring to FIG. 24.

The threshold information 901 stores an absolute value Th₁ of angular velocity (going) required when screen switching operation in each direction is to be instructed and an absolute value Th₂ of angular velocity (returning) required when the screen switching operation in each direction is actually performed. Thus, as absolute values of angular velocities of going and returning in each of four directions i.e. upward, downward, rightward and leftward directions, a rightward (going) angular velocity RgTh₁ and a leftward (returning) angular velocity LrTh₂ for a rightward swing, a leftward (going) angular velocity LgTh₁ and a rightward (returning) angular velocity RrTh₂ for a leftward swing, an upward (going) angular velocity UgTh₁ and a downward (returning) angular velocity DrTh₂ for an upward swing, and a downward (going) angular velocity DgTh₂ and an upward (returning) angular velocity UrTh₂ for a downward swing are determined as thresholds.

For each of these eight thresholds, there are two kinds of values, i.e. an initially-set value that is stored in advance and a user-set value that is set by the below-described threshold setting unit 914 on the basis of a user's motion. In the following, the motion analysis unit 911 uses mainly a user-set value for each threshold. However, it is assumed that, if the user-set value has not been set, the motion analysis unit 911 uses the initially-set value.

Further, in the present embodiment, the initially-set values are previously stored. However, it is possible to arrange that the user is made to perform a head swing motion in each direction when the power is turned on and angular velocities are sampled to set the initially-set values. Of course, it is possible that the initially-set values have been previously stored and, the user-set values are set and updated from the sampled angular velocities. A method of setting these set values will be described below.

Between Th₁ and Th₂ for each of the four directions, a larger value is determined for the direction (for example, the downward and the rightward directions) in which a head motion is easier than for the reverse direction. By employing this arrangement, it is possible to perform operation naturally in every direction. Of course, it is possible to set the same value for both directions.

Returning to FIG. 22, T₁ is a time point when it is detected that the absolute value of an angular velocity in some direction, i.e. AV(Z±) or AV(X±), becomes Th₁ or more. In FIG. 22, T₁ indicates a time point when it is detected that the rightward angular velocity AV(Z+) becomes larger than or equal to the rightward (going) threshold RgTh₁. At this point, the motion analysis unit 911 determines a set direction for the screen switching process.

The set direction determines the direction of screen switching, and is stored, for example as the setting information 902 as shown in FIG. 25, in the setting information storage area 922 of the storage area 920.

The setting information 902 comprises a set direction storage area 902a, a reverse direction detection flag storage area 902b, and an execution flag storage area 902c. The set direction storage area 902a stores information indicating the direction of angular velocity that has become more than or equal to Th1, such as Z+(rightward), Z−(leftward), X−(upward) or X+(downward) for example.

Further, the reverse direction detection flag storage area 902b registers a reverse direction detection flag indicating that angular velocity in the reverse direction to the set direction has been detected. The execution flag storage area 902c registers an execution flag indicating that the screen switching process has been already executed. These operations will be described later.

Returning to FIG. 22, T₂ is a time point when it is detected that the absolute value of the angular velocity in the set direction becomes Th₁ or less. In FIG. 22, T₂ indicates a time point when it is detected that the rightward angular velocity AV(Z+) becomes RgTh₁ or less. Here, when it is detected that the angular velocity in the set direction becomes Th₁ or less, the motion analysis unit 911 outputs a timer start request to the time measuring unit 912. Receiving the timer start request, the time measuring unit 912, makes the timer operate for the prescribed time until its time-out. The motion analysis unit 911 performs the screen switching process only when the angular velocity in the reverse direction to the set direction becomes Th₂ or more (time point T₄).

Timing of starting the timer is not limited to the above, and can be selected appropriately. For example, it is possible to select the time point T₁ or a time point when the absolute value of the angular velocity in the set direction becomes maximum, or the below-described time point T₃.

T₃ is a time point when angular velocity in the reverse direction to the set direction is detected. In FIG. 22, T3 indicates a time point when the leftward angular velocity AV(Z−) reverse to the rightward direction i.e. the set direction is detected. Here, the motion analysis unit 911 stores the reverse direction detection flag, which indicates detection of angular velocity in the reverse direction to the set direction, to the reverse direction detection flag storage area 902b of the setting information 902.

T₄ is a time point when it is detected that the absolute value of the angular velocity in the reverse direction to the set direction becomes Th₂ or more. In FIG. 22, T₄ indicates a time point when it is detected that the absolute value of the leftward angular velocity AV(Z−) becomes LrTh₂ or more. If the timer has not expired at this point, the motion analysis unit 911 outputs information indicating the angular velocity in the set direction to the signal control unit 913 to request the signal control unit 913 to perform the screen switching process, and stores the execution flag in the execution flag storage area 902c. If the timer has expired (See FIG. 23), the processing in question is not performed.

On receiving the information indicating the angular velocity in the set direction from the motion analysis unit 911, the signal control unit 913 generates a screen switching control signal for instructing the direction, the amount and the like of screen switching based on the received angular velocity. Then, the signal control unit 913 outputs the generated screen switching control signal to the display unit 160.

T₅ is a time point when the prescribed operation time of the timer elapses and the time measuring unit 912 stops the timer. In FIG. 22, the time point T₄ has been already passed through and the screen switching process has been already performed. In FIG. 23, the screen switching process is cancelled at the time point T₅ because the time point T₄ has not been passed through yet.

T6 is a time point when it is detected that the absolute value of the angular velocity in the reverse direction to the set direction becomes the prescribed Th₃ or less after the time point T₄ is passed through (after the screen switching process is performed), In FIG. 22, T₆ indicates a time point when it is detected that the absolute value of the leftward angular velocity AV(Z−) becomes the prescribed Th₃ or less. At this point, the motion analysis unit 911 outputs a threshold setting request to the threshold setting unit 914. If the timer has already expired without performing the screen switching process, the processing in question is not performed.

A threshold Th₃ is a prescribed value for indicating that a head swinging motion in each direction has been completed. In the case where the screen switching processes are performed successively, it is possible to arrange that, after starting the screen switching process at the time point T₄, the process in question is ended at the time point T₆. To prevent frequent screen switching, it is desirable that Th₃ is less than Th₁ and Th₂. For example it is desirable that Th₃ lies in the neighborhood of 0°/s (for example, −5°−5°) or is equal to 0°/s.

On receiving the threshold setting request, the threshold setting unit 914 first detects the maximum value of absolute values of angular velocities in the set direction and in the reverse direction to the set direction in the range from the time point T₁ at which the set direction was registered to the time point T₆ from the history of angular velocity.

Then, the threshold setting unit 914 calculates the threshold Th₁ based on the maximum value in the set direction and the threshold Th₂ based on the maximum value in the reverse direction, and updates the user-set values in the setting information 902.

As a method of setting the thresholds Th₁ and Th₂ based on both maximums, for example a value proportional to the maximum value or some percentage (for example, 80 percent) of the maximum value in each direction of angular velocity can be determined as a threshold. In the case where the maximum value does not lie in a prescribed range, the initially-set value itself may be set as the user-set value, or the average value of a value calculated from the maximum value and the initially-set value may be set as the user-set value.

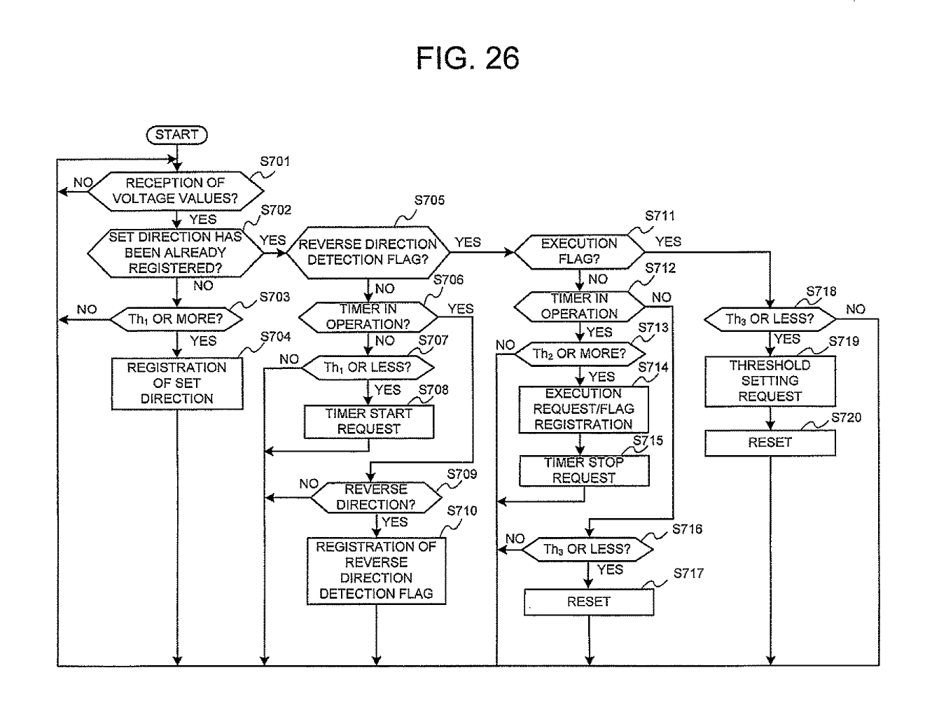

Next, operation performed by the motion analysis unit 911 will be described in detail referring to FIG. 26. FIG. 26 is a flowchart showing processing of screen switching performed by the motion analysis unit 911 of the fifth embodiment. The motion analysis unit 911 starts this flow when voltage values are received from the head motion detection unit 200.

The motion analysis unit 911 receives voltage values and calculates angular velocities (S701).

In detail, the motion analysis unit 911 receives voltage values outputted from the angular velocity sensor (Z) 201A and the angular velocity sensor (X) 201B at prescribed intervals (here, 50 msec). Then, the motion analysis unit 911 subtracts prescribed reference values from the received voltage values to calculate the true variations of the head motion, to obtain the angular velocities AV(Z±) and AV(X±).

Next, the motion analysis unit 911 judges whether the set direction has been already registered (or the time point T₁ has been passed through) (S702).

In detail, the motion analysis unit 911 refers to the set direction storage area 902a of the setting information 902 to judge whether the set direction has been registered or not. If the set direction has been already registered (YES), the processing proceeds to the step 705. Otherwise (NO), the processing proceeds to the step 703.

If it is judged in the step 702 that the set direction has not been registered yet (the time point T₁ has not been passed through) (NO), the motion analysis unit 911 judges whether the angular velocities calculated in the step 701 satisfy the threshold Th₁ for setting the screen switching direction (5703).

In detail, the motion analysis unit 911 judges whether one of the absolutes of the angular velocities AV(Z±) and AV(X±) is more than or equal to the threshold Th₁ corresponding to the direction of the angular velocity concerned. If there is an angular velocity whose absolute value is more than or equal to the threshold Th₁ concerned (YES), the direction of the angular velocity indicating the maximum absolute is registered as the set direction to the set direction storage area 902a (S704; the time point T₁). If there is not an angular velocity whose absolute value is more than or equal to the threshold Th₁ concerned (NO), the processing returns to the step 701 to repeat the processing.

If it is judged in the step 702 that the set direction has been already registered (the time point T₁ has been passed through) (YES), then the motion analysis unit 911 judges whether the reverse direction detection flag has been registered (the time point T₃ has been passed through) (S705).

In detail, the motion analysis unit 911 judges whether the reverse direction detection flag has been registered in the reverse direction detection flag storage area 902b of the setting information 902. If it has been already registered (YES), the processing proceeds to the step 711. Otherwise (NO), the processing proceeds to the step 706.

If it is judged in the step 705 that the set direction has not been registered yet (the time point T₃ has not been passed through) (NO), then the motion analysis unit 911 judges whether the timer is in operation (the time point T₂ has been passed through) (S706).

In detail, the motion analysis unit 911 inquires of the time measuring unit 912 whether the timer is in operation. In response to the inquiry, the time measuring unit 912 outputs an operating state of the timer to the motion analysis unit 911. If the timer is in operation (YES), the processing proceeds to the step 709. Otherwise (NO), the processing proceeds to the step 707.

If it is judged in the step 706 that the timer is not in operation (the time point T₂ has not been passed through) (NO), the motion analysis unit 911 judges whether the absolute value of the angular velocity in the set direction among the detected angular velocities is less than or equal to the threshold Th₁ corresponding to the direction in question (S707).

In detail, the motion analysis unit 911 judges whether the absolute value of the angular velocity in the set direction is less than or equal to the threshold Th₁ corresponding to the set direction. If the absolute value of the angular velocity in the set direction is more than the threshold Th₁ (NO), the processing returns to the step 701 to repeat the processing. If the absolute value of the angular velocity in the detected set direction is less than or equal to the threshold Th₁ (YES), the motion analysis unit 911 outputs a timer start request to the time measuring unit 912 (S708; the time point T₂), and the processing returns to the step 701 to repeat the processing.

If it is judged in the step 706 that the timer is in operation (the time point T₂ has been passed through) (YES), the motion analysis unit 911 judges whether angular velocity in the reverse direction to the set direction has been detected (S709).

In detail, the motion analysis unit 911 judges whether each of the angular velocities detected in the step 701 is in the reverse direction to the set direction. If angular velocity in the reverse direction to the set direction has not been detected (NO), the processing proceeds to the step 701 to repeat the processing. If angular velocity in the reverse direction to the set direction has been detected (YES), the motion analysis unit 911 registers the reverse direction detection flag in the reverse direction detection flag storage area 902b (S710; the time point T₃), the processing returns to the step 701 to repeat the processing.

It is judged in the step 705 that the reverse detection flag has been already registered (the time point T₃ has been passed through) (YES), the motion analysis unit 911 judges whether the execution flag has been registered (the time point T₄ has been passed through) (S711).

In detail, the motion analysis unit 911 judges whether the execution flag has been registered in the execution flag storage area 902c. If the execution flag has been already registered (YES), the processing proceeds to the step 718. Otherwise (NO), the processing proceeds to the step 712.

If it is judged in the step 711 that the execution flag has not been registered yet (the time point T₄ has not been passed through (NO), the motion analysis unit 911 judges whether a timer for regulating a time in which the screen switching process can be executed is in operation (S712).

In detail, the motion analysis unit 911 inquires of the time measuring unit 912 whether the timer is in operation. In response to the inquiry, the time measuring unit 911 outputs an operating state of the timer to the motion analysis unit 911. If the timer is in operation (YES), the processing proceeds to the step 713. Otherwise (NO), the processing proceeds to the step 716.

If it is judge in the step 712 that the timer is in operation (YES), the motion analysis unit 911 judges whether the absolute value of angular velocity in the reverse direction to the set direction satisfies the threshold Th₂ for executing the screen switching process (713).

In detail, the motion analysis unit 911 judges whether the absolute value of angular velocity in the reverse direction to the set direction among the angular velocities detected in the step 701 is more than or equal to the threshold Th₂ of the corresponding direction. If the absolute value is more than or equal to the threshold Th₂ (YES), the processing proceeds to the step 714. Otherwise (NO), the processing returns to the step 701 to repeat the processing.

If it is judged in the step 713 that the absolute value of angular velocity in the reverse direction to the set direction is more than or equal to the threshold Th₂ (YES), the motion analysis unit 911 requests the signal control unit 312 to perform the screen switching process (S714).

In detail, the motion analysis unit 911 outputs information indicating the angular velocity in the set direction to the signal control unit 913, to requests execution of the screen switching process. Then, the motion analysis unit 911 registers the execution flag in the execution flag storing area 902c (the time point T₄).

Then, the motion analysis unit 911 outputs a request for stop of the timer in operation to the time measuring unit 912 (S715), and the processing returns to the step 701 to repeat the processing. On receiving the timer stop request, the time measuring unit 912 stops the timer and resets its measured value.

If it is judged in the step 713 that the absolute value of the angular velocity in the reverse direction to the set direction is less than the threshold Th₂ of the corresponding direction (NO), the motion analysis unit 911 judges whether the absolute value of angular velocity in the set direction or the reverse direction to the set direction is less than or equal to the threshold Th₃ indicating completion of a head swing motion in the direction in question (S716).

In detail, the motion analysis unit 911 judges whether the absolute value of angular velocity in the set direction or the reverse direction to the set direction, which was detected in the step 701, is less than or equal to the threshold Th₃. If it is more than the threshold Th₃ (NO), the processing returns to the step 701 to repeat the processing. If it is less than or equal to the threshold Th₃ (YES), the motion analysis unit 911 judges that the head swing motion has been completed, deletes the information stored in the setting information 902, and outputs a request for stop of the timer in operation to the time measuring unit 912 (5717). Then, the processing returns to the step 701 to repeat the processing. Here, the motion analysis unit 911 may perform processing of notifying the user of non-execution of the screen switching process. The notification may be given through a warning screen, a character string, sound, blinking lamp of LED, or the like.

If it is judged in the step 711 that the execution flag has been registered (the time point T₄ has been passed through) (NO), the motion analysis unit 911 judges whether the absolute value of angular velocity in the set direction or the reverse direction to the set direction is less than or equal to the corresponding direction's threshold Th₃ indicating completion of the head swing motion (S718).

In detail, the motion analysis unit 911 judges whether the absolute value of angular velocity in the set direction or the reverse direction to the set direction, which was detected in the step 701, is less than or equal to the threshold Th₃. If it is more than the threshold Th₃ (NO), the processing returns to the step 701 to repeat the processing. If it is less than or equal to the threshold Th₃ (YES), the motion analysis unit 911 judges that the head swing motion has been completed, and outputs a threshold setting request to the threshold setting unit 914 (5719). Further, the motion analysis unit 911 deletes the information stored in the setting information 902, and outputs a request for stop of the timer in operation to the time measuring unit 912 (5720). Then, the processing returns to the step 701 to repeat the processing.

On receiving the threshold setting request, the threshold setting unit 914 extracts the maximum value among absolute values of angular velocities in the set direction and the reverse direction to the set direction in the range from the time point T₁ at which the set direction was registered to the time point T₆ from the history of angular velocity. Then, the threshold setting unit 914 updates the setting information 902 by taking a predetermined percent of the maximum value of angular velocity in the set direction as the threshold Th₁ for the user-set value corresponding to that direction and a predetermined percent of the maximum value of angular velocity in the reverse direction to the set direction as the threshold Th₂ for the user-set value corresponding to that direction.

Hereinabove, the processing performed by the control unit 910 of the fifth embodiment has been described.

According to the above-described configuration, the HMD 105 of the present embodiment can update appropriately the first threshold Th₁ for regulating angular velocity of a head swing motion in the going direction and the second threshold Th₂ for regulating angular velocity of return motion, on the basis of user's motion. Thus, these thresholds can be set as values appropriate to the use conditions of the HMD 105 and user's habit. As a result, the user can naturally make the HMD perform more accurate processing without causing malfunction.

Further, by registering the set direction by using the first threshold Th₁, it is possible to use only the angular velocities relating to the screen switching process, i.e. the angular velocities in the set direction and the reverse direction to the set direction. In other words, by disregarding angular velocities in the other directions, it is possible to prevent execution of unnecessary processing and to prevent detection of an unintended motion of the user.

### Sixth Embodiment

Next, a sixth embodiment of the present invention will be described. An HMD 106 according to the sixth embodiment differs from the embodiment of the fifth embodiment in threshold setting performed by the control unit. In the following, particulars concerning different points from the fifth embodiment will be mainly described.

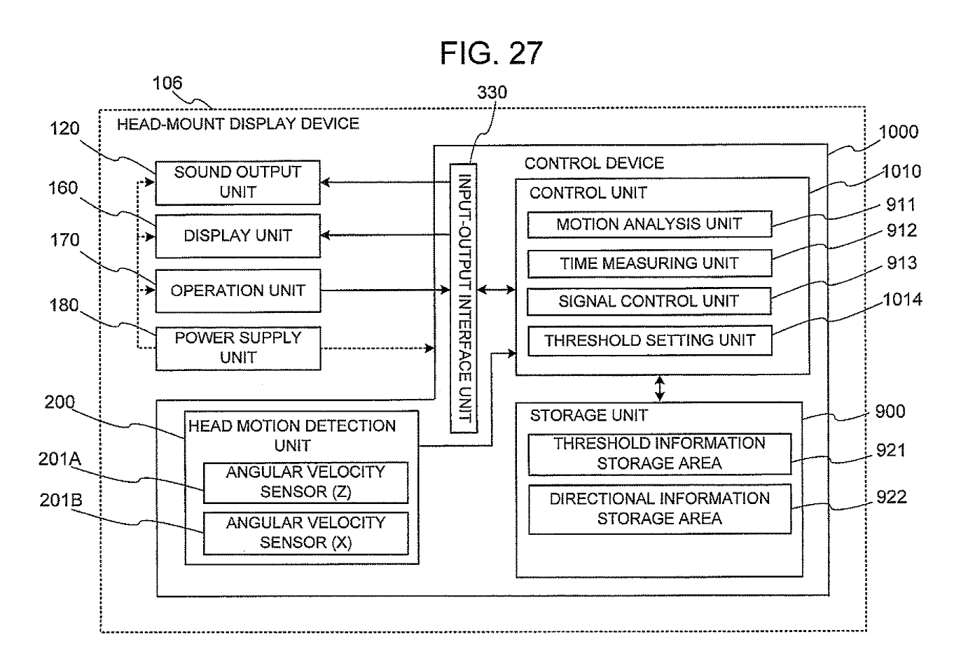

The HMD 106 will be described referring to FIG. 27. FIG. 27 is a block diagram showing a functional configuration of the HMD 106.

First, a control unit 1010 provided in the control device 1000 will be described. The control unit 1010 comprises a motion analysis unit 911, a time measuring unit 912, a signal control unit 913 and a threshold setting unit 1014.

The threshold setting unit 1014 performs approximate calculation of angular velocity from a history of angular velocity, and sets the user-set values of the thresholds Th₁ and Th₂ on the basis of the calculated function.

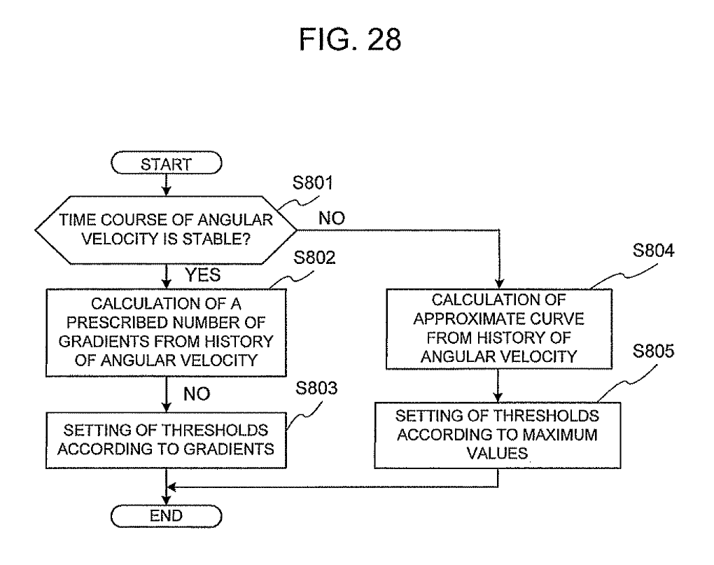

In the following, processing performed by the threshold setting unit 1014 will be described referring to FIG. 28. FIG. 28 is a flowchart showing a flow of threshold setting process performed by the threshold setting unit 1014.

When a threshold setting request is received from the motion analysis unit 911, the threshold setting unit 1014 starts the flow.

On receiving a threshold setting request from the motion analysis unit 911, the threshold setting unit 1014 first refers to an angular velocity history to judge whether time course of angular velocity is stable or not (S801).

In detail, the threshold setting unit 1014 judges stability of the time course of angular velocity. For example, if the zones showing an increase in velocity and a decreasing in velocity are repeated, within a period while, the head is swinging toward one direction and returning to its initial position, the threshold setting unit 1014 judges stability by monitoring the number of times such a repetition of change in velocity being emerged.

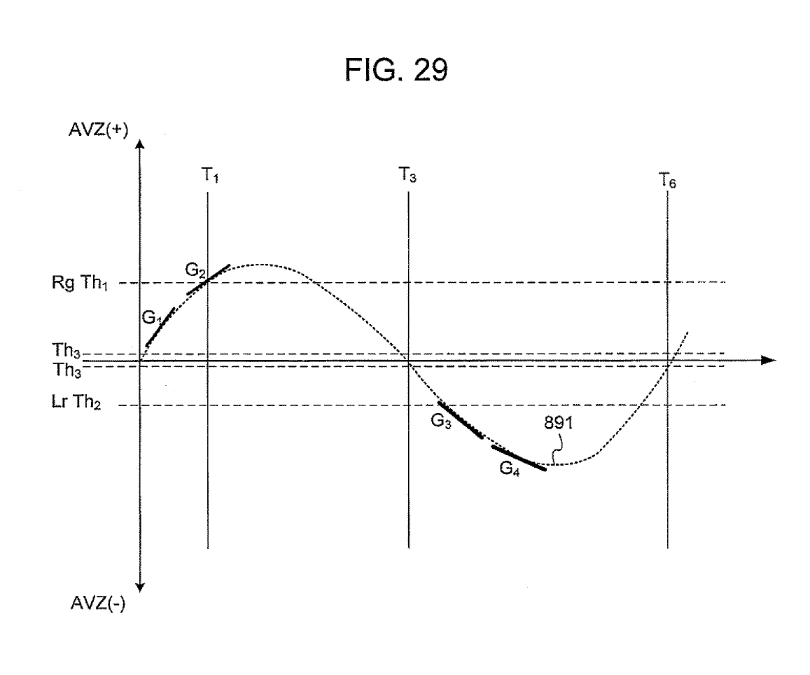

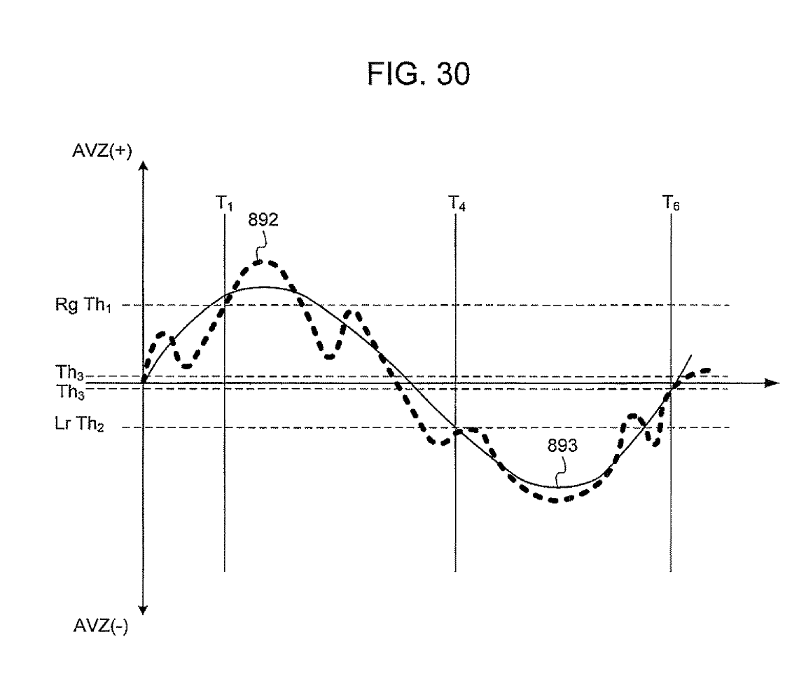

For example, in the case where, as shown in FIG. 29, time course of angular velocity is expressed as a curve 891 having tow extreme points, it is judged that the time course of angular velocity is stable (YES), and the processing proceeds to the step 802. However, in the case where, as shown in FIG. 30, time course of angular velocity is expressed as a curve 892 having three or more extreme points, it is judged that the time course of angular velocity is not stable (NO), and the processing proceeds to the step 804.

If it is judged in the step 801 that the time course of angular velocity is stable (YES), the threshold setting unit 1014 calculates a prescribed number of gradients from the angular velocity history (S802).

In detail, the threshold setting unit 1014 calculates gradients of the prescribed number of tangent lines, i.e. differential coefficients, as shown in FIG. 29 in a range between a point where angular velocity in the set direction exceeds Th₃ and a point where the absolute value of the angular velocity reaches its maximum and a range between a point where the reverse direction detection flag is registered and a point where the absolute value of angular velocity in the reverse direction reaches its maximum. Interval where differentiation is performed may be determined based on angular velocity detected in a prescribed period or angular velocity detected by a prescribed number of times. In the case of FIG. 29, four gradients G₁-G₄ were calculated.

Next, the threshold setting unit 1014 calculates and sets thresholds corresponding to the gradients obtained in the step 802 (S803).

In detail, the threshold setting unit 1014 calculates Th₁ from the gradients G₁ and G₂ and Th₂ from the gradients G₃ and G₄. For example, in the case where the average value of the gradients concerned is larger, it means that the head is moved at a higher speed. Thus, in such a case, a larger value is set to the threshold Th₁ or Th₂ in proportion to the average value of the gradients concerned. And, the threshold setting unit 1014 updates the user-set values of the corresponding directions in the threshold information 901 to the calculated thresholds Th₁ and Th₂, and ends the processing.

If it is judged in the step 801 that the time course of angular velocity is not stable (NO), the threshold setting unit 1014 calculates an approximate curve from the history of angular velocity (S804).

In detail, as shown in FIG. 30, the threshold setting unit 1014 performs approximate calculation, for example, by the least squares method based on the curve 892 generated from the history of angular velocity, and obtains an approximate curve 893 as a result of calculation.

Then, the threshold setting unit 1014 calculates and sets thresholds according to the approximate curve 893 (S805).

In detail, the threshold setting unit 1014 obtains the maximum absolute values of the approximate curve 893 from its absolute values in the set direction and the reverse direction to the set direction. Then, similarly to the fifth embodiment, the threshold setting unit 1014 sets some percentage (for example, 80 percent) of the maximum value in the set direction as Th₁, and some percentage (for example, 80 percent) of the maximum value in the reverse direction as Th₂. Then, the threshold setting unit 1014 updates the user-set values of the corresponding directions in the threshold information 901 to the calculated thresholds Th₁ and Th₂, and ends the processing.

Hereinabove, the threshold setting process performed by the threshold setting unit 1014 has been described.

According to the above-described configuration, the HMD 106 of the present embodiment updates appropriately the thresholds for executing the screen switching process on the basis of the velocity of a head swing motion. As a result, it is possible to perform processing adapted always for the user.

Further, even when angular velocity shows unstable time course, more suitable thresholds can be set by using an approximation of the time course.

Further, the present invention is not limited to the above-described embodiments. The above embodiments can be variously modified within the technical idea of the present invention.

For example, the threshold setting unit 1014 of the embodiment is arranged to set Th₁ proportionally to the values of G₁ and G₂. A similar method may be employed to set Th₂ proportionally to the values of G₁ and G₂, and Th₁ proportionally to G₃ and G₄. Further, Th₁ and Th₂ may be set proportionally to the values of G₁ and G₂. Or, Th₁ and Th₂ may be set proportionally to the values of G₃ and G₄.

Similarly, by employing a method similar to the above embodiment, the threshold setting unit of the present invention may be arranged to set the threshold Th₂ proportional to the maximum value in the set direction and the threshold T₁ proportional to the maximum value in the reverse direction. Of course, Th₁ and Th₂ may be set in proportion to the maximum value in the set direction. Or, Th₁ and Th₂ may be set in proportion to the maximum value in the reverse direction.

According to such arrangement, the processing can be started when the reverse direction detection flag is registered (at the time point T₃), and the threshold Th₂ can be set until the time point T₄ by calculating the maximum value in the reverse direction or the gradients G₁ and G₂, and thus the motion analysis unit 311 can use the threshold Th₂ calculated from the most recent head swing motion.

Further, when the threshold setting unit updates the threshold Th₁ for the set direction, all thresholds Th₁ and Th₂ for all directions also may be updated to values proportional to the variation of the threshold Th₁.

In the case where the time course of angular velocity is one shown in FIG. 23 in the first embodiment, the screen switching process is cancelled and no processing is performed. However, it may be arranged that, if the angular velocity does not become LrTh₂ or more between T₂ and T₅ in FIG. 23, processing different from the screen switching process performed in FIG. 22 (for example, the scroll process) is performed.

Further, application of the control devices described in the above-described embodiments is not limited to an HMD. The above-described control devices can be applied to other devices having a head motion detection unit.

The HMD of the present invention is arranged such that one eye is used to view a screen image. However, it may be arranged such that both eyes are used to view a screen image.

Further, in the above embodiments, the display unit 160 is positioned such that it comes within a view of the user's left eye. The present invention is not limited to this. The HMD may be arranged to be positioned such that a screen comes within a view of the user's right eye. Or, the HMD may be arranged like eyeglasses so that a screen comes within a view of both eyes.

The present invention can be applied not only to an HMD but also to surround headphones and the like in order to control sounds from right and left speakers according to a user's motion to make the user feel as if he were listening to the original sound.

The present invention can be applied to provide computer programs that realize the steps of the control method according to the present invention and make a computer function as the control unit of the present invention.

Further, the present invention can be applied to a storage medium that stores computer programs realizing the steps of the control method according to the present invention.

The present invention can be implemented in various other ways without departing from the gist and main features of the invention. Thus, the above-described embodiments are only examples in all senses, and should not be taken as limiting the invention. Further, all the variations and modifications belonging to the equivalent of the claims are within the scope of the invention.

Further, application of the control devices in the above-described embodiments is not limited to an HMD. The above-described control devices can be applied to other devices having a head motion detection unit.

1. A head-mount display to be worn on a user's head, comprising:
a housing;
a display unit which is placed in the housing, and configured to display an image for the user who wears the head-mount display;
a sensor unit which is placed within the housing, and configured to detect an information with respect to a velocity of the user's head motion;
a control unit which is placed within the housing, and configured to perform either one of a first control to control the head-mount display or a second control differs from the first control, based on the information detected by the sensor unit.

2. The head-mount display of claim 1, wherein:
the control unit is configured to perform the second control when the information is larger than a first predetermined value and the first control when the information is smaller than the first predetermined value.

3. The head-mount display of claim 1, wherein
the sensor unit is configured to detect the information in a first direction and the control unit is configured to perform the first control or the second control based on the information in the first direction.

4. The head-mount display of claim 3, wherein
the control unit is configured to perform:
the second control when the information in the first direction is larger than the first predetermined value; and
the first control when the information in the first direction is smaller than the first predetermined value.

5. The head-mount display of claim 4, wherein
the control unit is configured to, after the second control, not carry out the first control or a subsequent second control based on the information, until the sensor unit detects information in a second direction which is different from the information in the first direction.

6. The head-mount display of claim 1, wherein
the control unit is configured to not carry out the first control or the second control based on the information for a predetermined period of time after performing the second control. unit.

7. The head-mount display of claim 2, wherein
the control unit is configured to change the first predetermined value.

8. The head-mount display of claim 1, wherein
the control unit is configured to perform the first control or the second control to control the display

9. The head-mount display of claim 1, wherein
the control unit is configured to perform the first control to scroll an image displayed on the display unit, and to perform the second control to switch an image displayed on the display unit to another image.

10. The head-mount display of claim 1, wherein
the display unit is configured to display the information.

11. The head-mount display of claim 1, further comprising:
a operation unit which is operated by the user, wherein the control unit is configured to change a function related to the head-mount display based on an operation on the operation unit.

12. The head-mount display of claim 11, wherein
the control unit is configured to perform an instruction to an image displayed on the display unit based on the operation on the operation unit.

13. The head-mount display of claim 1, wherein
the sensor unit is either an angular velocity sensor or an acceleration sensor.

14. The head-mount display of claim 1, wherein
the information with respect to a velocity of the user's head motion is either an angular velocity, an acceleration or a velocity of the user's head motion.

15. A control method of a head-mount display to be worn on a user's head, comprising:
displaying an image to the user who wears the head-mount display;
detecting an information with respect to a velocity of the user's head motion; and
performing either a first control to control the head-mount display or a second control which is different form the first control, based on the detected information.

16. The control method of a head-mount display of claim 15, further comprising:
performing the second control when the information is larger than a first predetermined value; and
performing the first control when the information is smaller than the first predetermined value.

17. The control method of a head-mount display of claim 15, further comprising:
detecting the information on a first direction; and
performing a control based on the information in the first direction.

18. The control method of a head-mount display of claim 17, further comprising:
performing:
the second control when the information in the first direction is larger than the first predetermined value; and
the first control when the information in the first direction is smaller than the first predetermined value.

19. The control method of a head-mount display of claim 17, further comprising:
not carrying out the first control or a subsequent second control based on the information after performing the second control until a sensor unit detects information in a second direction which is different from the information in the first direction.

20. The control method of a head-mount display of claim 15, further comprising:
not carrying out the first control or a subsequent second control based on the information for a predetermined period of time after performing the second control.

21. The control method of a head-mount display of claim 16, further comprising:
changing the first predetermined value to a different predetermined value.

22. The control method of a head-mount display of claim 15, further comprising:
performing the first control or the second control to control the image, the image being displayed on a display unit of the head-mount display.

23. The control method of a head-mount display of claim 15, wherein
the first control controls scrolling an image displayed on a display unit of the head-mount display, and
the second control controls switching an image displayed on the display unit to another image.

24. The control method of a head-mount display of claim 15, further comprising:
displaying the information.

25. The control method of a head-mount display of claim 15, further comprising:
acquiring an input of an operation done by the user on an operation unit of the head-mount display; and
changing a function related to the head-mount display based on an operation done by the user.

26. The control method of a head-mount display of claim 25, further comprising:
providing instructions to an image displayed on a display unit of the head-mount display based on the operation done by the user on the operation unit.
